(19) United States
(12) Patent Application Publication
(10) Pub. No.: US 2012/0101213 A1
(43) Pub. Date: Apr. 26, 2012

(54) HIGHLY WATER-REPELLENT POLYIMIDE FOR COPIER MEMBER, AND POLYAMIC ACID COMPOSITION

(75) Inventors: Kozo Tajiri, Osaka (JP); Go Masuda, Osaka (JP); Tomomi Makino, Osaka (JP); Atsushi Okada, Osaka (JP)

(73) Assignee: NIPPON SHOKUBAI CO, LTD, Osaka-Shi (JP)

(21) Appl. No.: 13/379,840

(22) PCT Filed: Jun. 28, 2010
(86) PCT No.: PCT/JP2010/060967

§ 371 Date: Dec. 21, 2011

(30) Foreign Application Priority Data
Jun. 26, 2009 (JP) 2009-151982
Aug. 7, 2009 (JP) 2009-184947
Nov. 12, 2009 (JP) 2009-259178

(51) Int. Cl. C08G 73/10; C08K 3/04; C08L 79/08

(52) U.S. Cl. 524/538; 528/185; 528/208

(57) ABSTRACT

Provided are a polyimide which is inexpensive, has various excellent material properties including strength, heat resistance, low moisture absorption, mold releasability (detachability), dielectric properties, electrical properties, and optical properties, and can exhibit a high level of water repellency, and a polyamic acid composition useful as a raw material therefor. Also provided are the polyimide which can give a polyimide composition that, besides having such excellent material properties, is capable of having a controlled surface resistivity, and a polyamic acid composition useful as a raw material therefor. The polyimide is a highly water-repellent polyimide for copier members which is obtained using one or more acid dianhydrides and one or more diamine compounds, and is characterized in that at least one of the acid dianhydrides and the diamine compounds is a compound having an ether bond and/or a thioether bond in the molecule and that the total number of ether bonds and thioether bonds in the repeating unit constituting the polyimide and derived from the acid dianhydrides and the diamine compounds is 2 or larger.

### TECHNICAL FIELD

The present invention relates to a highly water-repellent polyimide for copier members and a polyamic acid composition. The present invention specifically relates to a polyimide which can exert strength, heat resistance, hygroscopic resistance, mold releasability (detachability), dielectricity, and water repellency, and which are useful for copier members; and a polyamic acid composition.

### BACKGROUND ART

Polyimides are known to be obtainable by imidizing a polyamic acid which is synthesized from an acid dianhydride and a diamine compound as reaction materials. They have high strength and excellent heat resistance and are excellent in properties such as dielectricity and electrical properties, owing to their imide rings, and thus polyimides are applied to various uses such as electric and electronic components, machine components, and optical components. Polyimides are currently expected to simultaneously have various characteristics depending on their uses. In the case of using a polyimide for protecting films, mold-release materials, or the like of components used under damp atmosphere, for example, their surfaces are required to have water repellency and mold releasability (detachability). In addition, uses as belts for fixing and transfer (belt-shaped sheets and films) in image-forming and image-recording devices such as copiers, facsimiles, printers, and all-in-one printers are examined as one use of polyimides. Conventional image-forming and image-recording devices employ a system wherein an image formed on an image carrier (e.g. a photosensitive drum) using a developer (e.g. toner) is directly fixed on a recording medium. In contrast, current devices are employing a system wherein an image on an image carrier is transferred or fixed on a recording medium through a belt-shaped sheet or film, such as a fixing belt and a transfer belt, for the purpose of improving the life of devices and fixing speed.

The aforementioned uses as copier members require a polyimide capable of exerting strength, heat resistance, hygroscopic resistance, mold releasability (detachability), dielectricity, and water repellency. Water repellency can be imparted to a polyimide by a known technique in which fluorine is introduced in the molecular structure of a polyimide by, for example, introducing a fluorinated alkyl group or introducing a fluorine-substituted group into the main skeleton of the polyimide, so that the water absorption of the polyimide is reduced. For example, Patent Documents 1 and 2 disclose a technique in which a polyimide is produced from a diamine having a fluorine atom or a fluorine-substituted alkyl group in its molecule. Specifically, Patent Document 1 discloses a diamine having one, two, or four benzene rings and a fluorine atom and/or a fluorine-substituted alkyl group, and Patent Document 2 discloses a diamine having one or two benzene rings and a fluorine-substituted alkyl group.

Further, Patent Document 3 discloses, as one example of polyimides used for belts for conventional image-forming and image-recording devices, a polyimide for transfer belts produced as follows: a specific carbon black is dispersed in an organic polar solvent, and then water is added thereto to prepare a carbon black dispersion; an acid dianhydride component and a diamine component are dissolved into this dispersion and polymerized therein; the polyimide is produced from the carbon black-dispersed polyamic acid solution obtained by the polymerization. Further, Patent Document 4 discloses, as a fixing film, a material mainly containing a fluorinated polyimide with fluororesin dispersed and mixed therein.

### PRIOR ART REFERENCES

### Patent Documents

Patent Document 1: JP 11-21350 A (pages 2 and 3)
Patent Document 2: JP 3425854 B (pages 2 and 3)
Patent Document 3: JP 2002-292656 A (pages 2, 4, and 5)
Patent Document 4: JP 3069041 B (page 1 and others)

### SUMMARY OF THE INVENTION

### Problems to be Solved by the Invention

As mentioned above, conventionally, water repellency is imparted to a polyimide by a technique of introducing a fluorine-substituted group or a fluorinated alkyl group into the main skeleton of the polyimide using, as a reaction material, a diamine compound having a fluorine atom and/or a fluorine-substituted alkyl group. However, further improvement is expected in the production of a polyimide which can more sufficiently exert various physical properties that the polyimide originally has, such as heat resistance, hygroscopic resistance, water repellency, and mold releasability, especially excellent water repellency and hygroscopic resistance, at low cost using inexpensive and industrially easily available monomers. In addition, further improvement is expected in controlling of the surface resistance (electric resistance) of polyimides.

The present invention is devised in consideration of the aforementioned situation, and aims to provide a polyimide which is inexpensive, which is excellent in various physical properties such as strength, heat resistance, hygroscopic resistance, mold releasability (detachability), dielectricity, electrical properties, and optical properties, and which exerts water repellency at high level, and a polyamic acid composition useful as the material thereof. The present invention further aims to provide a polyimide which can provide a polyimide composition not only excellent in the above physical properties but also capable of controlling the surface resistance value, and a polyamic acid composition useful as the material thereof.

### Means for Solving the Problems

The present inventors have performed various studies on highly water repellent polyimides, and found that a polyimide having a certain amount or more of an ether linkage and/or a thioether linkage in its molecule have extremely improved water repellency and have flexibility. Specifically, in the case that at least one compound of acid dianhydrides and diamine compounds which form a polyamic acid (which are the materials of a polyimide) has an ether linkage and/or a thioether linkage in its molecule and the total number of ether linkages and thioether linkages in polymerized repeating units derived from the acid dianhydrides and the diamine compounds constituting the polyimide is 2 or greater, flexibility is imparted or the flexibility is improved, and the water repellency and the hygroscopic resistance become extremely excellent. Further, the present inventors have found that such a polyimide can be obtainable from a compound which is inexpensive and more easily industrially available, and the polyimide is not only extremely excellent in water repellency and hygroscopic resistance, but also high in strength and excellent in various physical properties such as heat resistance, chemical resistance, mold releasability, dielectricity, electrical properties, and optical properties, thereby particularly useful for uses as copier members which particularly require water repellency. Furthermore, they have found that in the case of using such a polyimide for such a use, the above effects of the polyimide are particularly extremely exerted. Here, the copier members (components) are preferably fixing and transfer belts, for example, and the polyimide of the present invention is suitably applied to these uses.

The present inventors have further found that a fluorinated polyamic acid obtainable from a specific perfectly fluorinated acid dianhydride and diamine compound and a polyamic acid composition containing carbon black and/or fluororesin among the polyamic acids as materials of the aforementioned polyimide can provide a polyimide composition which can sufficiently exert the aforementioned various physical properties and control the surface resistance value within a certain range. Thereby, the present inventors have arrived at the solution of the above problems and completed the present invention.

That is, the present invention relates to a highly water-repellent polyimide for copier members, comprising: one or more acid dianhydrides; and one or more diamine compounds, wherein at least one compound of the acid dianhydrides and the diamine compounds includes an ether linkage and/or a thioether linkage in its molecule, and the total number of ether linkages and thioether linkages in polymerized repeating units derived from the acid dianhydrides and the diamine compounds of the polyimide is 2 or greater.

The present invention also relates to a polyamic acid composition for preparing highly water-repellent polyimides for copier members, comprising a polyamic acid obtainable from one or more acid dianhydrides and one or more diamine compounds, wherein at least one compound of the acid dianhydrides and the diamine compounds includes an ether linkage and/or a thioether linkage in its molecule, and the total number of ether linkages and thioether linkages in polymerized repeating units derived from the acid dianhydrides and the diamine compounds of the polyamic acid is 2 or greater.

The uses of the highly water-repellent polyimide for copier members and the polyamic acid composition for preparing highly water-repellent polyimides for copier members of the present invention are not limited to copier members, and may be various uses such as electric and electronic components, machine components, and optical components.

The following will describe the present invention.

The highly water-repellent polyimide for copier members (hereinafter, also referred to simply as the polyimide) of the present invention is obtainable from an acid dianhydride and a diamine compound. More specifically, the polyimide is obtainable by imidizing a polyamic acid obtainable by reacting an acid dianhydride and a diamine compound. The acid dianhydride and the diamine compound as the material components each may include one or more types thereof. At least one compound of the acid dianhydrides and the diamine compounds has an ether linkage and/or a thioether linkage in its molecule. In other words, one or more compounds used here of the acid dianhydrides and/or the diamine compounds forming the polyimide (and the polyamic acid) have an ether linkage and/or a thioether linkage in the molecule. For example, part or all of the compounds corresponding to either the acid dianhydrides or the diamine compounds may be a compound having an ether linkage and/or a thioether linkage in its molecule. Alternatively, part or all of the compounds corresponding to the acid dianhydrides and part or all of the compounds corresponding to the diamine compounds both may be a compound having an ether linkage and/or a thioether linkage in its molecule. Particularly preferable embodiment is an embodiment in which one or more compounds having an ether linkage in the molecule is included in both the acid dianhydrides and the diamine compounds.

In the polyimide and the polyamic acid, an appropriate total number of the ether linkages and the thioether linkages in the polymerized repeating units derived from the acid dianhydride and the diamine compound is 2 or greater. In other words, an appropriate total number of the ether linkages and the thioether linkages in the polymerized repeating units derived from the acid dianhydride and the polymerized repeating units derived from the diamine compound constituting the polyimide (and the polyamic acid) is 2 or greater. Thereby, sufficient flexibility is imparted to the polyimide to be obtained, and the water repellency thereof is extremely improved. The total number is more preferably 3 or greater, and further preferably 4 or greater.

The total number of the ether linkages and the thioether linkages means the sum of the number of ether linkages and the number of thioether linkages. This does not necessarily mean that the polyimide and the polyamic acid of the present invention essentially comprise both an ether linkage and a thioether linkage. For example, in the case that the polyimide and the polyamic acid of the present invention comprise an ether linkage and do not comprise a thioether linkage, the total number of ether linkages and thioether linkages of the polyimide and the polyamic acid corresponds to the sum of the number of ether linkages. In other words, in the polyimide and the polyamic acid, either an ether linkage or a thioether linkage may exist in the polymerized repeating units with the total number of 2 or greater, or both an ether linkage and a thioether linkage may exist therein with the total number of 2 or greater, as long as the total number of ether linkages and thioether linkages in the polymerized repeating units derived from the acid dianhydride and the diamine compound is 2 or greater.

One preferable embodiment of the present invention among these is a highly water-repellent polyimide for copier members obtainable from one or more acid dianhydrides and one or more diamine compounds wherein at least one compound of the acid dianhydrides and the diamine compounds has an ether linkage in its molecule and the total number of the ether linkages is 3 or greater in the polymerized repeating units derived from the acid dianhydrides and the diamine compounds constituting the polyimide. In addition, another preferable embodiment of the present invention is a polyamic acid composition for preparing highly water-repellent polyimides for copier members, comprising a polyamic acid obtainable from one or more acid dianhydrides and one or more diamine compounds, wherein at least one compound of the acid dianhydrides and the diamine compounds has an ether linkage in its molecule, and the total number of ether linkages in the polymerized repeating units derived from the acid dianhydrides and the diamine compounds constituting the polyamic acid is 3 or greater.

The ether linkage is a linkage represented by —O—. The number of ether linkages in the present invention does not include the number of —O— parts in acid anhydride groups (—C(O)—O—C(O)— parts) of the acid dianhydrides.

The number of ether linkages and thioether linkages can be calculated from the number of ether linkages and thioether linkages in a compound having an ether linkage and/or a thioether linkage in its molecule and the reaction molar ratio of the compound having an ether linkage and/or a thioether linkage in its molecule. Examples of the calculation method will be mentioned below, but not limited to the following embodiments.

(1) In the case of producing a polyamic acid composition by reacting an acid dianhydride having two ether linkages per molecule and a diamine compound having neither ether linkage nor thioether linkage in its molecule at a molar ratio of 1/1 and producing a polyimide therefrom, the total number of ether linkages and thioether linkages is 2×1+0×1=2. Also, in the case of producing a polyamic acid composition by reacting an acid dianhydride having neither ether linkage nor thioether linkage and a diamine compound having two ether linkages per molecule at a molar ratio of 1/1 and producing a polyimide therefrom, the calculation is performed in the same manner and the number is 2.

(2) In the case of producing a polyamic acid composition by reacting an acid dianhydride having two ether linkages per molecule and a diamine compound having one ether linkage per molecule at a molar ratio of 1/1 and producing a polyimide therefrom, the total number of ether linkages and thioether linkages is 2×1+1×1=3. Also, in the case of producing a polyamic acid composition by reacting an acid dianhydride having one ether linkage per molecule and a diamine compound having two ether linkages per molecule at a molar ratio of 1/1 and producing a polyimide therefrom, the calculation is performed in the same manner and the number is 3.

(3) In the case of producing a polyamic acid composition by reacting an acid dianhydride a having two ether linkages per molecule, an acid dianhydride b having neither ether linkage nor thioether linkage in its molecule, and a diamine compound having one ether linkage per molecule at a molar ratio of 0.5/0.5/1.0 and producing a polyimide therefrom, the total number of ether linkages and thioether linkages is 2×0.5+0×0.5+1×1=2.

(4) In the case of producing a polyamic acid composition by reacting an acid dianhydride having two ether linkages per molecule, a diamine compound a having one ether linkage per molecule, and a diamine compound b having two ether linkages per molecule at a molar ratio of 1/0.5/0.5 and producing a polyimide therefrom, the total number of ether linkages and thioether linkages is 2×1.0
+1×0.5+2×0.5=3.5.

As mentioned above, the reaction molar ratio of the material components is set such that the total amount of all the acid dianhydrides and that of all the diamine compounds are equimolar to each other.

The ether linkage and/or the thioether linkage of the at least one compound of the acid dianhydrides and the diamine compounds are preferably linkages which do not disappear through the reaction between the acid dianhydrides and the diamine compounds and the imidization reaction. In other words, the polyimide preferably has a structural unit including an ether linkage and/or a thioether linkage derived from the acid dianhydrides and/or the diamine compounds in its main chain skeleton. Such a polyimide preferably has a structural unit represented by formula (1):

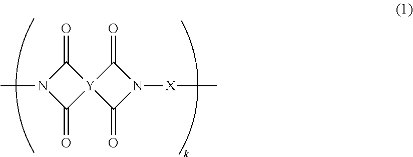

wherein X represents a diamine compound residue and is a divalent organic group; Y represents an acid dianhydride residue and is a tetravalent organic group; k represents the repeating number of the structural units represented by formula (1), and is 1 or greater; the sum of the ether linkages and the thioether linkages in X and Y is 2 or greater. The polyimide is more preferably in an embodiment wherein the sum of the ether linkages and the thioether linkages in X and Y in formula (1) is 3 or greater, and further preferably in an embodiment wherein the sum of the ether linkages and the thioether linkages in X and Y in formula (1) is 4 or greater. As a result, the effect of extremely high water repellency of the present invention can be more sufficiently exerted. Also, preferably, all the ether linkages and/or thioether linkages in X and Y in formula (1) may be ether linkages.

As mentioned above, the polyimide is obtainable by imidizing a polyamic acid which is obtainable by reacting an acid dianhydride and a diamine compound. The polyamic acid preferably has a structural unit represented by formula (2):

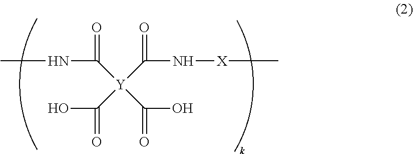

wherein X represents a diamine compound residue and is a divalent organic group; Y represents a tetravalent organic group; k represents the repeating number of the structural units represented by formula (2), and is 1 or greater; and the sum of the ether linkages and the thioether linkages in X and Y is 2 or greater. The polyamic acid is more preferably in an embodiment wherein the sum of the ether linkages and the thioether linkages in X and Y in formula (2) is 3 or greater, and further preferably in an embodiment wherein the sum of the ether linkages and the thioether linkages in X and Y in formula (2) is 4 or greater. Also, preferably, all the ether linkages and/or the thioether linkages in X and Y in formula (2) may be ether linkages.

Here, k is preferably 1 to 1,000. If k is greater than 1,000, the viscosity may be too high and, in the case of preparing a polyamic acid composition by mixing the polyamic acid with other components such as carbon black and fluororesin, the compatibility of the polyamic acid with the other components may be insufficient. In such a case, the polyamic acid may be diluted with a solvent or the like as appropriate. More preferably, k is 2 to 500.

The molecular weight of the polyamic acid is preferably 1,000 to 1,000,000 in terms of weight average molecular weight. If the molecular weight is less than 1,000, better heat resistance and the like properties may not be imparted, whereas if the molecular weight is more than 1,000,000, the polyamic acid may be gelled in the polyamic acid composition. The molecular weight is more preferably 5,000 to 700,000, and further preferably 10,000 to 500,000.

In particular, the polyamic acid preferably has a weight average molecular weight of 10,000 to 200,000. This is because a polyimide film produced from a polyimide that is prepared from such a polyamic acid as the material can have increased abrasion resistance.

The weight average molecular weight is determined using a gel permeation chromatograph (GPC) based on the calibration curve of standard polystyrene in the same manner as the following examples.

The reason why the abrasion resistance of the polyimide film is high in the case of producing the film from the polyamic acid with a weight average molecular weight of 10,000 to 200,000 as the material is probably that the following two phenomena occur.

(i) A polyamic acid is obtainable by equimolar polymerization between an acid dianhydride and a diamine compound. In this polymerization reaction, water in the reaction system reacts with part of the acid dianhydride, and the acid dianhydride is ring-opened and caused to have a phthalic acid structure. The acid dianhydride with the phthalic acid structure is less likely to react with a diamine compound at low temperature, and thus serves as a terminal of the polymerization. In other words, a phthalic acid group and an amino group exist on ends of the polyamic acid to be synthesized at equal probability. In the imidization step, two carboxylic acids at the ends each react with an amino group at an end of another polyamic acid, and thus two amide bonds are formed. Thereby, a cross-linking structure with amide bonds is formed. The cross-linking density is higher as the molecular weight of the polyamic acid is lower. As a result, a polyimide film produced from a polyamide having a cross-linking structure formed with a high density has improved strength (abrasion resistance).

(ii) In the case of producing a polyimide film containing carbon black, a polyamic acid composition containing a polyamic acid and carbon black is used as the material of the polyimide film. The functional group (e.g. a carboxylic acid and a hydroxy group) on the surface of the carbon black and the amines and carboxylic acids at ends of a polyamic acid to be synthesized react with each other and grafted in the heating process (firing) for producing a polyimide. The grafting rate is higher as the number of the amines and carboxylic acids at the ends of the polyamic acid is larger. Thus, the grafting rate is higher as the molecular weight of the polyamic acid to be synthesized is lower. Here, the produced polyimide film is polished and the carbon black particles slide down from the polymer matrix of the polyimide film, and thereby abrasion occurs. If a structure that increases compatibility at the interface between the carbon black particles and the polymer exists in the polyimide film, the sliding down can be prevented; in this case, the grafts have an effect of increasing the compatibility. As a result, grafting of the polyamic acid and the carbon black at high rate suppresses sliding down of the carbon black particles by polishing, and thereby the abrasion resistance increases.

Owing to the effects (i) and/or (ii), the polyimide film produced from a polyamic acid with a weight average molecular weight of 10,000 to 200,000 as the material can probably have improved abrasion resistance. If the weight average molecular weight of the polyamic acid is 10,000 or lower, disadvantageously, the viscosity of the polyamic acid to be obtained is very low and production of a polyimide film may be difficult.

The polyimide and the polyamic acid also preferably satisfy the relationship (the total molecular weight of oxygen and sulfur in ether linkage and/or thioether linkage)/(the total molecular weight of unit)=0.05 or higher in the polymerized unit. This value is more preferably 0.07 or higher.

Here, the total molecular weight of oxygen and sulfur in ether linkage and/or thioether linkage is the sum of the number of oxygen atoms in ether linkages and the number of sulfur atoms in thioether linkages. This does not necessarily mean that the polyimide and the polyamic acid of the present invention essentially have both an ether linkage and a thioether linkage. In the case that the polyimide and the polyamic acid of the present invention have an ether linkage and do not have a thioether linkage, for example, the total molecular weight of oxygen and sulfur in ether linkage and/or thioether linkage of the polyimide and the polyamic acid is the sum of the number of oxygen atoms in the ether linkage.

The polyamic acid is obtainable from one or more acid dianhydrides and one or more diamine compounds, and the structure of the polyamic acid depends on the acid dianhydrides to be used and the diamine compounds to be used. The polyamic acid of the present invention has three preferable embodiments, and the following will describe these first to third preferable embodiments in order.

In the first preferable embodiment of the polyamic acid of the present invention, the acid dianhydride used as the material is preferably a compound represented by formula (3), and the compound may be of aromatic or may be of aliphatic. Particularly preferable are aromatic acid anhydrides. Here, Y in formula (3) corresponds to Y in each of formulas (1) and (2) and represents a tetravalent organic group. Preferable examples thereof include aliphatic organic groups which may have a straight chain or a branched chain, or a ring; aromatic organic groups; organic groups wherein two or more aliphatic groups and/or aromatic groups are bonded to each other via a carbon atom; and organic groups wherein two or more aliphatic groups and/or aromatic groups are bonded to each other via an atom other than a carbon atom (e.g. oxygen atom, nitrogen atom, and sulfur atom).

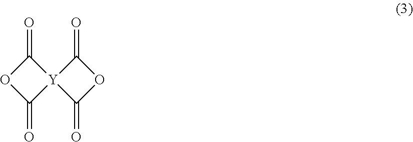

Preferable as the acid dianhydride having an ether linkage and/or a thioether linkage in its molecule among the acid dianhydrides are the following compounds, for example:

4,4′-oxydiphthalic anhydride, 3,3′,4,4′-biphenylether tetracarboxylic dianhydride, 2,3′,3,4′-biphenylether tetracarboxylic dianhydride, 4,4′-bis(3,4-dicarboxyphenoxy)diphenyl sulfide dianhydride, 4,4′-bis(3,4-dicarboxyphenoxy)diphenyl sulfonic acid dianhydride, 4,4′-bis(3,4-dicarboxyphenoxy)diphenyl propionic acid dianhydride, 5,5′-bis(trifluoromethyl)-3,3′,4,4′-tetracarbon diphenyl ether acid dianhydride, 1,4-bis(3,4-dicarboxytrifluorophenoxy)tetrafluorobenzoic dianhydride, 1,4-bis(3,4-dicarboxytrifluorophenoxy)tetrachlorobenzoic dianhydride, 1,4-bis(3,4-dicarboxytrifluorophenoxy)octafluorobiphenyl acid dianhydride, and 1,4-bis(3,4-dicarboxytrifluorophenoxy)benzoic acid dianhydride.

Preferable among the acid dianhydrides having an ether linkage and/or a thioether linkage in the molecule are compounds having two or more ether linkages and/or thioether linkages per molecule. Particularly preferable are compounds represented by formula (4):

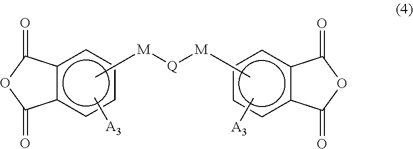

wherein A represents a hydrogen atom or a fluorine atom; Q represents a divalent organic group; and M represents an oxygen atom or a sulfur atom. The polyimide having a structure derived from such an acid dianhydride can have much better properties such as solubility into organic solvents, heat resistance, hygroscopic resistance, water repellency, and mold releasability. The embodiment wherein the acid dianhydrides used in the present invention include at least the compound represented by formula (4) is also one preferable embodiment of the present invention.

In particular, M is preferably an oxygen atom. The embodiment wherein the acid dianhydrides used in the present invention include at least the compound represented by formula (4) and M in formula (4) represents an oxygen atom is also one preferable embodiment of the present invention.

Examples of the divalent organic group represented by Q include divalent aliphatic organic groups which may include a straight chain or branched chain, or a ring; aromatic organic groups; divalent organic groups wherein two or more aliphatic groups and/or aromatic groups are bonded via a carbon atom; and divalent organic groups wherein two or more aliphatic groups and/or an aromatic groups are bonded via an atom other than a carbon atom (e.g. oxygen atom, nitrogen atom, and sulfur atom). Specifically, preferable examples thereof include divalent aliphatic organic groups derived from cyclic alkyls, chain alkyls, olefin, glycol, and the like; divalent aromatic organic groups derived from benzene, biphenyl, biphenyl ether, bisphenyl benzene, bisphenoxy benzene, and the like; and divalent organic groups wherein these aliphatic organic groups and/or aromatic organic groups are bonded via a carbon atom, oxygen atom, nitrogen atom, or sulfur atom. Preferable among these are divalent organic groups represented by formulas (5-1) to (5-7):

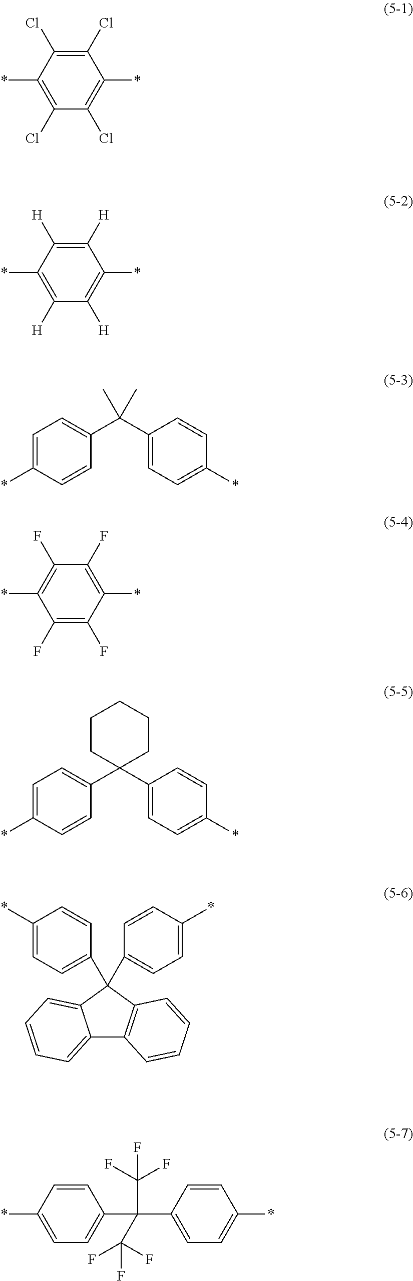

wherein the portion represented by the symbol “*”,bonds to M in formula (4). Particularly preferable among these are those represented by formulas (5-2) and (5-4).

The divalent organic group represented by Q may have at least one halogen atom (preferably a fluorine atom) or a halogenated alkyl group (a halogen-substituted alkyl group). Thereby, a polyimide excellent in various physical properties such as heat resistance, chemical resistance, water repellency, dielectricity, electrical properties, and optical properties may be easily obtained in some cases. If the divalent organic group represented by Q has such a structure, especially, it is preferably a group that has a benzene ring having at least one fluorine atom or halogenated alkyl group. Further, the halogenated alkyl group is more preferably a C1-C20 alkyl fluorine group (e.g. trifluoromethyl group). The divalent organic group represented by Q is particularly preferably a group that has a benzene ring fully substituted by a fluorine atom or a C1-C20 alkyl fluorine group.

Specific examples of the compound represented by formula (4) include compounds represented by formulas (6-1) to (6-5) (1,4-bis(3,4-dicarboxytrifluorophenoxy)tetrachlorobenzoic dianhydride, 1,4-bis(3,4-dicarboxytrifluorophenoxy)benzoic dianhydride, 1,4-bis(3,4-dicarboxyphenoxy)benzoic dianhydride, 1,4-bis(3,4-dicarboxyphenoxy)tetrafluorobenzoic dianhydride, and 1,4-bis(3,4-dicarboxytrifluorophenoxy)tetrafluorobenzoic dianhydride); compounds represented by formula (6-6) such as 2,2-bis{4-(3,4-dicarboxyphenoxy)phenyl}propane dianhydride and 2,2-bis{4-(3,4-dicarboxytrifluorophenoxy)phenyl}propane dianhydride; compounds represented by formula (6-7) such as 1,1-bis{4-(3,4-dicarboxyphenoxy)phenyl}cyclohexane dianhydride and 1,1-bis{4-(3,4-dicarboxytrifluorophenoxy)phenyl}cyclohexane dianhydride; compounds represented by formula (6-8) such as 9,9-bis{4-(3,4-dicarboxyphenoxy)phenyl}fluorene dianhydride and 9,9-bis{4-(3,4-dicarboxytrifluorophenoxy)phenyl}fluorene dianhydride; and compounds represented by formula (6-9) such as 2,2-bis{4-(3,4-dicarboxyphenoxy)phenyl}hexafluoropropane dianhydride and 2,2-bis{4-(3,4-dicarboxytrifluorophenoxy)phenyl}hexafluoropropane dianhydride.

In formulas (6-6) to (6-9), Zs are the same as or different from each other, and each represent a hydrogen atom or a fluorine atom. Here, Zs may be the same as or different from each other in each organic group, and may be the same as or different from each other in each benzene ring. It is particularly preferable to use one or more of these acid dianhydrides represented by formulas (6-1) to (6-9).

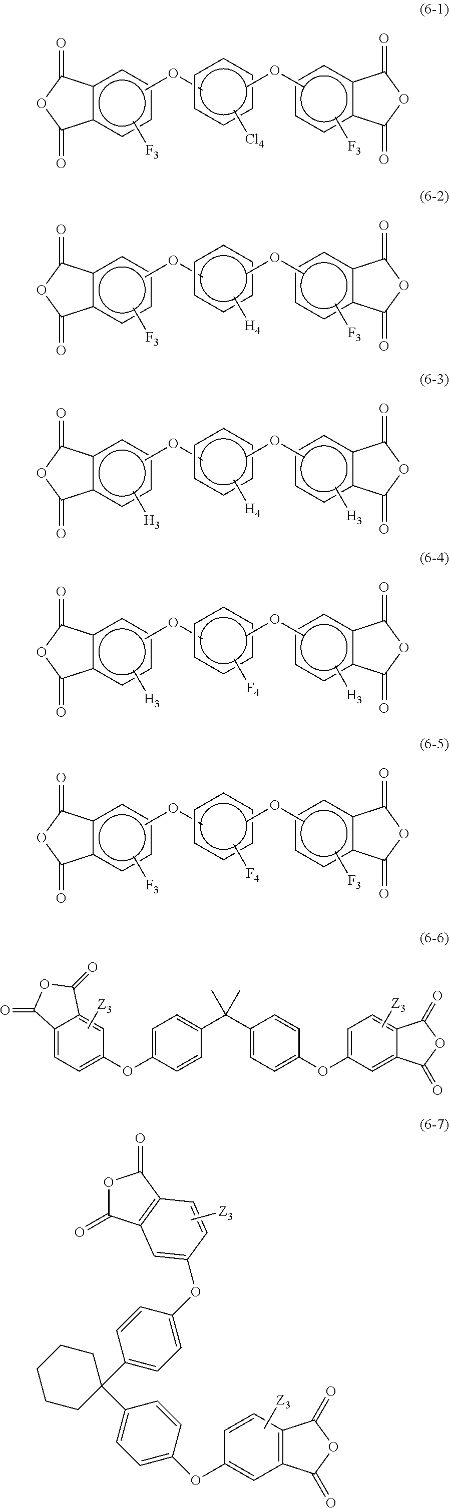

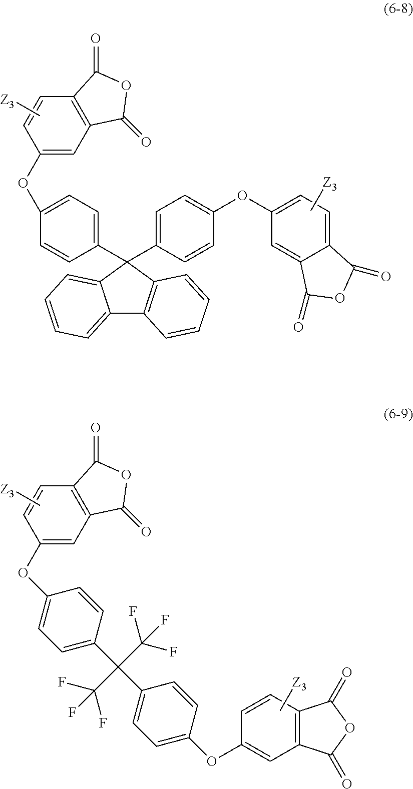

In the case of using a diamine compound having an ether linkage and/or a thioether linkage in its molecule, an acid dianhydride having no ether linkage in its molecule may be used as appropriate. Preferable examples of the acid dianhydride having no ether linkage in its molecule include the following compounds:
aromatic tetracarboxylic anhydrides such as pyromellitic dianhydride, 3,3′,4,4′-benzophenone tetracarboxylic dianhydride, 3,3′,4,4′-biphenylsulfone tetracarboxylic dianhydride, 3,3′,4,4′-tetracarboxydiphenyl methanoic dianhydride, 1,4,5,8-naphthalene tetracarboxylic dianhydride, 1,2,5,6-naphthalene tetracarboxylic dianhydride, 2,3,6,7-naphthalene tetracarboxylic dianhydride, 2,6-dichloronaphthalene-1,4,5,8-tetracarboxylic dianhydride, 2,7-dichloronaphthalene-1,4,5,8-tetracarboxylic dianhydride, 2,3,6,7-tetrachloronaphthalene-1,4,5,8-tetracarboxylic dianhydride, 1,2,3,4-furane tetracarboxylic dianhydride, 2,3,4,5-thiophenetetracarboxylic dianhydride, 3,3′,4,4′-biphenyltetracarboxylic dianhydride, bis(phthalic acid)phenylphosphine oxide dianhydride, 3,3′,4,4′-perfluoroisopropylidene diphthalic dianhydride, difluoropyromellitic dianhydride, dichloropyromellitic dianhydride, trifluoromethylpyromellitic dianhydride, 1,4-di(trifluoromethyl)pyromellitic dianhydride, di(heptafluoropropyl)pyromellitic dianhydride, pentafluoroethyl pyromellitic dianhydride, bis{3,5-di(trifluoromethyl)phenoxy}pyromellitic dianhydride, 5,5′-bis(trifluoromethyl)-3,3′,4,4′-tetracarboxybiphenyl acid dianhydride, 1,2′,5,5′-tetrakis(trifluoromethyl)-3,3′,4,4′-tetracarboxybiphenyl acid dianhydride, 5,5′-bis(trifluoromethyl)-3,3′,4,4′-tetracarboxybenzophenolic dianhydride, 3,4,9,10-tetracarboxyperylenic dianhydride, 3,3′,4,4′-dimethyldiphenylsilane tetracarboxylic dianhydride, 3,3′,4,4′-tetraphenylsilane tetracarboxylic dianhydride, and 1,3-bis(3,4-dicarboxyphenyl)tetramethyldisiloxane acid dianhydride;
aliphatic or alicyclic tetracarboxylic dianhydrides such as butanetetracarboxylic dianhydride, 1,2,3,4-cyclobutane tetracarboxylic dianhydride, 1,3-dimethyl-1,2,3,4-cyclobutane tetracarboxylic acid, 1,2,3,4-cyclopentane tetracarboxylic dianhydride, 2,3,5-tricarboxycyclopentylacetic dianhydride, 3,5,6-tricarboxynorbornane-2-acetic dianhydride, 2,3,4,5-tetrahydrofurane tetracarboxylic dianhydride, 5-(2,5-dioxotetrahydrofural)-3-methyl-3-cyclohexene-1,2-dicarboxylic dianhydride, and bicyclo[2,2,2]-oct-7-ene-2,3,5,6-tetracarboxylic dianhydride; and aliphatic tetracarboxylic dianhydrides such as 1,3,3a,4,5,9b-hexahydro-2,5-dioxo-3-furanyl)-naphth[1,2-c]furane-1,3-dione, 1,3,3a.4,5,9b-hexahydro-5-methyl-5-(tetrahydro-2,5-dioxo-3-furanyl)-naphth[1,2-c]furane-1,3-dione, 1,3,3a,4,5,9b-hexahydro-8-methyl-5-(tetrahydro-2,5-dioxo-3-furanyl)-naphth[1,2-c]furane-1,3-dione.

The diamine compound used in the first preferable embodiment of the polyamic acid of the present invention is preferably a compound represented by formula (7).

H₂N—X—NH₂ (7)

Here, X in formula (7) corresponds to X in formulas (1) and (2), and represents a divalent organic group. Examples thereof include divalent aliphatic organic groups which may include a straight chain or branched chain, or a ring; aromatic organic groups; divalent organic groups wherein two or more aliphatic groups and/or aromatic groups are bonded via a carbon atom; and divalent organic groups wherein two or more aliphatic groups and/or an aromatic groups are bonded via an atom other than a carbon atom (e.g. oxygen atom, nitrogen atom, and sulfur atom). Specifically, preferable examples thereof include divalent aliphatic organic groups derived from cyclic alkyls, chain alkyls, olefin, glycol, and the like; divalent aromatic organic groups derived from benzene, biphenyl, biphenyl ether, bisphenyl benzene, bisphenoxy benzene, and the like; and divalent organic groups wherein these aliphatic organic groups and/or aromatic organic groups are bonded via a carbon atom, oxygen atom, nitrogen atom, or sulfur atom.

The divalent organic group represented by X may be one wherein at least part of hydrogen atoms forming C—H bonds that should exist in the group if the group is not substituted is replaced with a fluorine atom and/or a halogenated alkyl group (this is also referred to as a halogen-substituted alkyl group). Thereby, a polyimide which is excellent in various physical properties such as heat resistance, chemical resistance, water repellency, dielectricity, electrical properties, and optical properties may be easily obtained in some cases. In the case that the divalent organic group represented by X has such a structure, the halogenated alkyl group preferably has 1 to 20 carbon atoms and the halogen atom therein is preferably a fluorine atom. More preferable is a C1-C20 alkyl fluorine group (also referred to as a fluorine-substituted alkyl group). In the embodiment wherein the divalent organic group represented by X has at least one fluorine atom or a halogenated alkyl group, particularly preferably, all of the hydrogen atoms of C—H bonds are replaced with fluorine atoms and/or C1-C20 alkyl fluorine groups. In the case that all the C—H bonds of the divalent organic group are substituted by fluorine atoms and/or C1-C20 alkyl fluorine groups as mentioned above, the aforementioned effects are further improved.

Specifically, the divalent organic group represented by X is preferably a group represented by formulas (8-a) to (8-i):

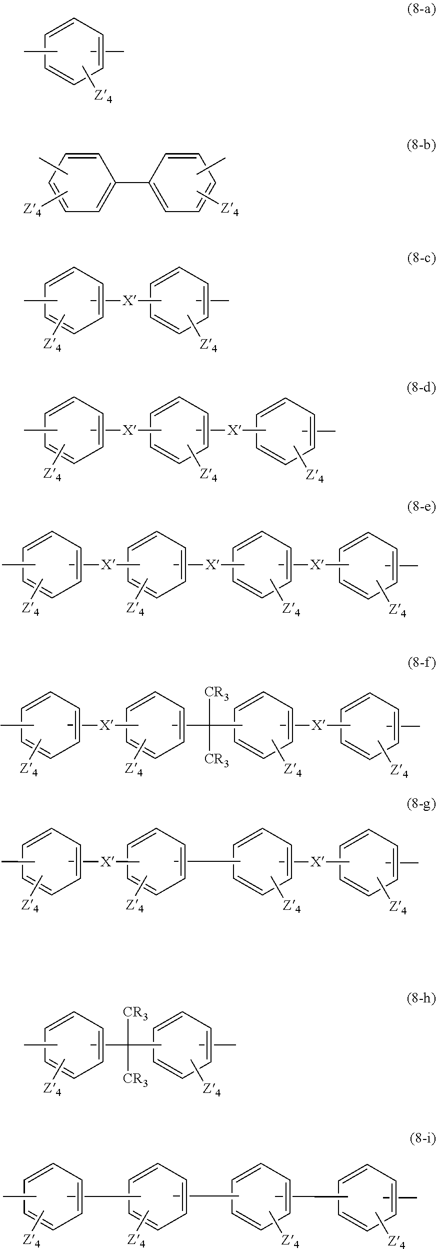

wherein Z's may be the same as or different from each other, and each represent a hydrogen atom (in other words, not substituted), an alkyl group or an aryl group which may be substituted by a substituent, or a halogen atom (fluorine atom, chlorine atom, bromine atom, or iodine atom); Z's in each organic group may be the same as or different from each other, and may be the same as or different from each other in each benzene ring; Rs may be the same as or different from each other, and each represent a fluorine atom or a hydrogen atom; and X's each represent an oxygen atom, nitrogen atom, carbon atom, —S—, or —SO₂—, and X's may be the same as or different from each other. An embodiment wherein the group is a compound of formula (8-d) with all Z's being hydrogen atoms is particularly preferable among these.

The organic groups represented by formulas (8-a) to (8-i) may have at least one fluorine atom or halogenated alkyl group (halogen-substituted alkyl group). In other words, at least one group represented by Z′ in each organic group may be a fluorine atom or a halogenated alkyl group. Thereby, a polyimide excellent in various physical properties such as heat resistance, chemical resistance, water repellency, dielectricity, electrical properties, and optical properties may be easily obtained in some cases. In the case that the organic groups represented by formulas (8-a) to (8-i) have such a structure, in particular, the benzene ring of each organic group preferably has at least one fluorine atom or halogenated alkyl group. Further, the halogenated alkyl group is more preferably a C1-C20 alkyl fluorine group (e.g. trifluoromethyl group). Particularly preferably, all of Z's of each organic group are fluorine atoms or C1-C20 alkyl fluorine groups.

Preferable among these as the divalent organic groups represented by X are the groups represented by formulas (8-a), (8-b), (8-c), and (8-d). Particularly preferable examples of the diamine compound include 2,3,5,6-tetrafluoro-1,4-diaminobenzene, 1,3-diamino-2,4,5,6-tetrafluorobenzene (4FMPD), 4,4′-diamino-2,2′-bis(trifluoromethyl)biphenyl (TFMB), bis(4-aminophenyl)ether (ODA), 2,2-bis(4-(4-aminophenoxy)phenyl)hexafluoropropane (HFBAPP), 4,4′-bis(4-aminophenoxy)biphenyl (BAPB), 1,4-bis(4-aminophenoxy)benzene (TPE-Q), bis(2,3,5,6-tetrafluoro-4-aminophenyl)ether (8FODA), 1,4-diamino-2-tridecafluorohexyl benzene (13FPD), and bis(octafluoro-4′-aminobiphenyl-4-yl)ether (16FPD).

The diamine compound having an ether linkage and/or a thioether linkage in its molecule is preferably one having an ether linkage and/or a thioether linkage among the diamine compounds represented by the aforementioned formula (7).

In the reaction step of the acid dianhydride(s) and the diamine compound(s), that is, the polymerization reaction step for obtaining a polyamic acid in the first preferable embodiment of the present invention, the blending ratio of these materials is preferably such that the total amount of the diamine compounds is 0.6 to 1.4 mol for 1 mol in total of the acid dianhydrides. Thereby, a polyamic acid composition and a polyimide having better properties such as heat resistance and hygroscopic resistance can be obtained. The ratio of the diamine compounds is more preferably 0.75 to 1.25 mol.

The reaction step of the acid dianhydride(s) and the diamine compound(s) is preferably performed in an organic solvent.

The organic solvent is not particularly limited as long as it causes efficient progress of the reaction between the diamine compounds and the acid dianhydrides which are materials of a polyamic acid and is inert to these materials. Examples thereof include polar solvents such as N-methylpyrrolidone, N-methyl-2-pyrrolidinone, N,N-dimethylacetamide, N,N-dimethyl formamide, tetrahydrofurane dimethyl sulfoxide, sulfolane, methylisobutyl ketone, acetonitrile, benzonitrile, nitrobenzene, nitromethane, dimethyl sulfoxide, acetone, methylethyl ketone, isobutyl ketone, and methanol; and non-polar solvents such as toluene and xylene. Particularly preferable are polar solvents. Each of these organic solvents may be used alone or two or more thereof may be used in combination.

The amount of the organic solvent is not particularly limited as long as the polymerization reaction for obtaining a polyamic acid efficiently proceeds. For example, the total amount of the materials of a polyamic acid (acid dianhydrides and diamine compounds) is preferably set to 1 to 60% by mass for 100% by mass in total of the organic solvent and the materials of the polyamic acid. This is more preferably 3 to 50% by mass.

The reaction conditions of the reaction step are not particularly limited as long as the materials of the polyamic acid can sufficiently react with each other. Preferably, for example, the reaction is performed in the air (preferably in an inert gas atmosphere such as nitrogen, helium, and argon) and the polymerization reaction temperature is set to −20° C. to 80° C. The polymerization reaction temperature is more preferably 0° C. to 50° C. The polymerization reaction time is preferably 1 hour to 10 days, and more preferably 1 to 7 days.

As mentioned above, examples of the method for synthesizing a low molecular weight polyamic acid having a weight average molecular weight of 10,000 to 200,000 include commonly employed methods, that is, in general, a method wherein an additive (e.g. water) that cleaves part of acid dianhydrides which are the reaction materials is added upon polymerization of a polyamic acid, and a method of controlling the temperature upon polymerization of a polyamic acid. Particularly preferable among these is a method of adding water upon polymerization of a polyamic acid because this method can be industrially inexpensively performed.

In the second preferable embodiment of the polyamic acid of the present invention, the diamine compound used as the material preferably has a structure represented by formula (9):

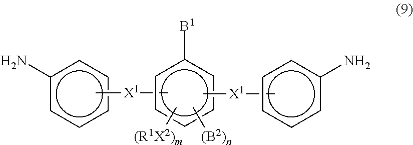

wherein B¹ represents CF₃ or CN; B²s are the same as or different from each other, and each represent H, F, Cl, Br, or I; R¹ represents a C1-C20 halogen-substituted alkyl group; X¹s are the same as or different from each other, and each represent O or S; X² represents O or S; n represents the number of B²s, and is an integer of 0 to 2; m represents the number of substitutions in the group represented by R¹X², and is an integer of 1 to 3; and n+m=3.

The diamine compound represented by formula (9) is a compound having three benzene rings. In this diamine compound, part or all of the hydrogen atoms in one of the benzene rings is/are replaced with one of a cyano group and a trifluoromethyl group and one of a halogen-substituted alkoxy group and a halogen-substituted alkylthio group, and this benzene ring is coupled with the other two benzene rings each having an amino group via an oxygen atom (O) or a sulfur atom (S). Such a diamine compound is an unprecedented novel compound, and is useful as a material of a polyimide excellent in properties such as heat resistance, chemical resistance, water repellency, dielectricity, electrical properties, and optical properties. In particular, a halogen-substituted alkoxy group or a halogen-substituted alkylthio group not only enables control of the refractive index, but also gives hygroscopic resistance and excellent water repellency. In addition, coupling of the one benzene ring with the other two benzene rings each having an amino group via an ether linkage or a thioether linkage leads to flexibility and further extremely improved water repellency. Therefore, the compound is suitable for uses especially requiring water repellency. As mentioned above, the embodiment in which the diamine compound used in the present invention includes the compound represented by formula (9) is also one preferable embodiment of the present invention.

Here, the diamine compound represented by formula (9) is an unprecedented novel compound. Thus, it can also be used in various uses (e.g. optical material uses), as well as a material for a polyamic acid and a polyimide. As mentioned above, the diamine compound represented by formula (9) is also one aspect of the present invention.

In formula (9), R¹ represents a halogen-substituted alkyl group. The halogen-substituted alkyl group is a group wherein at least part of the hydrogen atoms bonding to the carbon atoms of the alkyl group is replaced with a halogen atom. The structure thereof is not particularly limited and may be any of a straight chain, branched chain, and cyclic alkyl group. Further, it may have an ether linkage in the halogen-substituted alkyl group.

The halogen atom is preferably a fluorine atom (F), chlorine atom (Cl), bromine atom (Br), or iodine atom (I), and the hydrogen atoms may be replaced with two or more of these atoms. From the viewpoint of controlling the refractive index, a chlorine atom (Cl) and a fluorine atom (F) are preferable among these, and from the viewpoint of improving the solubility and water repellency, a fluorine atom (F) is more preferable. As mentioned above, the embodiment wherein R¹ is a C1-C20 fluorine-substituted alkyl group is also one preferable embodiment of the present invention.

The diamine compound represented by formula (9) has at least one halogen-substituted alkoxy group or halogen-substituted alkylthio group comprising such a halogen-substituted alkyl group and an oxygen atom (O) or a sulfur atom (S). The synergy effect of this group and two ether linkages or thioether linkages represented by X¹ further improves flexibility and enables to exert extremely excellent water repellency and mold releasability (detachability).

An appropriate number of carbon atoms in the halogen-substituted alkyl group is 1 to 20. In consideration of the properties such as solubility and water repellency, the carbon number is preferably 2 to 18, and more preferably 3 to 15.

In the halogen-substituted alkyl group, the total number of the halogen atoms coupled with the carbon atoms is preferably larger than the total number of the hydrogen atoms coupled with the carbon atoms. If the total number of the halogen atoms is smaller than the total number of the hydrogen atoms, the water repellency may not be more sufficiently exerted. Assuming that the total number of the hydrogen atoms is 100% in the case that the halogen-substituted alkyl group is not substituted, for example, the total number of the halogen atoms in the halogen-substituted alkyl group is preferably higher than 50%. In consideration of easy producibility and properties such as water repellency, the total number of the halogen atoms is more preferably 60% or higher, and further preferably 70% or higher.

Particularly preferable examples of the halogen-substituted alkyl group include those represented by the following formulas.

### CF₃—(CF₂)₇—(CH₂)₂—

### CF₃—(CF₂)₉—(CH₂)₂—

### CF₃—(CF₂)₂—CH₂—

### CF₃—(CF₂)₃—CH₂—

### CHF₂—(CF₂)₇—CH₂—

### (CF₃)₂—CF(CF₂)₂—(CH₂)₂—

### CF₃CH₂—

### HCF₂CH₂—

### F(CF₂)₂CH₂—

### CHF₂CF₂CH₂—

### (CF₃)₂CH—

### CF₃CH₂CH₂—

### H(CF₂)₂CH₂—

### Cl(CF₂)₂CH₂—

### (CF₃)C(CH₃)H—

### F(CF₂)₃CH₂—

### F(CF₂)₂(CH₂)₂—

### CF₃CHFCF₂CH₂—

### CF₃(CH₂)₃—

### F(CF₂)₂C(CH₃)H—

### CF₃C(CH₃)₂—

### CH₃C(CF₃)₂—

### (CF₃)₄C—

### (CF₃)₂C(CCl₃)—

### F(CF₂)₄—CH₂—

### F(CF₂)₃(CH₂)₂—

### F(CF₂)₂(CH₂)₃—

### CF₃(CH₂)₄—

### (CF₃)₂CFCH₂CH₂—

### (CF₃)₂—O—(CH₃)CH₂—

### H(CF₂)₄—CH₂—

### Cl(CF₂)₄CH₂—

### Br(CF₂)₂(CH₂)₃—

### CF₃CH₂CH(CH₃)CH₂—

### CF₃CF(OCF₃)CH₂CH₂—

### (CF₃)₂CHOCH₂CH₂—

### F(CF₂)₃C(CH₃)H—

### F(CF₂)₅CH₂—

### F(CF₂)₄(CH₂)₂—

### F(CF₂)₃(CH₂)₃—

### F(CF₂)₂(CH₂)₄—

### (CF₃)₂CF(CH₂)₃—

### (CF₃)₃CCH₂CH₂—

### CF₃CF(OCF₃)(CH₂)₃—

### F(CF₂)₃OCF(CF₃)CH₂—

### H(CF₂)₅CH₂—

### F(CF₂)₂C(CH₃)₂—

### CF₃CHFCF₂C(CH₃)₂—

### F(CF₂)₆CH₂—

### F(CF₂)₅(CH₂)₂—

### F(CF₂)₄(CH₂)₃—

### (CF₃)₂CF(CF₂)₂(CH₂)₂—

### (CF₃)₂CFCHFCF(CF₃) CH₂—

### CF₃CF₂CF(CF₃)(CH₂)₃—

### H(CF₂)₆CH₂—

### Cl(CF₂)₆CH₂—

### F(CF₂)₇CH₂—

### F(CF₂)₆(CH₂)₂—

### F(CF₂)₅(CH₂)₃—

### F(CF₂)₄(CH₂)₄—

### F(CF₂)₂(CH₂)₆—

### F(CF₂)₃OCF(CF₃)(CH₂)₃—

### (CF₃)₃—O—(CH₂)₄—

### H(CF₂)₇CH₂—

### F(CF₂)₆CH₂—

### F(CF₂)₆(CH₂)₃—

### (CF₃)₂CF(CH₂)₆—

### (CF₃)₂CF(CF₂)₄(CH₂)₂—

### F(CF₂)₃OCF(CF₃)CF₂OCF(CF₃)CH₂—

### H(CF₂)₈CH₂—

### F(CF₂)₄(CH₂)₆—

### CF₃ (CF₂)₇(CH₂)₂—

### F(CF₂)₈(CH₂)₃—

### (CF₃)₂CF(CF₂)₆(CH₂)₂—

### H(CF₂)₁₀CH₂—

### F(CF₂)₆(CH₂)₆—

### F(CF₂)₁₀(CH₂)₂—

### H(CF₂)₁₂CH₂—

### F(CF₂)₉(CH₂)₆—

In formula (9), m represents the number of substitution of the group represented as a R¹X² group (halogen-substituted alkoxy group or halogen-substituted alkylthio group), and is an integer of 1 to 3. In order to obtain a polyimide with higher water repellency, m is preferably as great as possible. The value of m is more preferably 2 or 3, and further preferably 3.

In formula (9), B²s are the same as or different from each other, and each represent H, F, Cl, Br, or I. In order to further improve properties such as heat resistance, water repellency, hygroscopic resistance, and dielectricity, at least one B² is preferably a halogen atom (F, Cl, Br or I). In particular, two B²s in formula (9) are preferably halogen atoms. Further, a chlorine atom (Cl) and a fluorine atom (F) are preferable among the halogen atoms, and a fluorine atom (F) is more preferable. Thereby, the water repellency and the hygroscopic resistance are further improved, and the polyimide serves as a more useful material for various applications. Particularly preferably, two B²s in formula (9) both are fluorine atoms (F). The embodiment wherein the B²s are F (fluorine atoms) is also one preferable embodiment of the present invention.

The method for producing the diamine compound represented by formula (9) is preferably the following Production Methods (a) and (b), for example. In these methods, the diamine compound represented by formula (9) is efficiently produced.

Production Method (a): a method comprising Step (a-1) of reacting the compound represented by formula (10) with a halogen-containing alkyl alcohol and/or a halogen-containing alkyl thiol, and Step (a-2) of reacting the compound represented by formula (11a) obtained in Step (a-1) with an aminophenol and/or an aminothiophenol.

Production Method (b): a method comprising Step (b-1) of reacting the compound represented by formula (10) with an aminophenol and/or an aminothiophenol, and Step (b-2) of reacting the compound represented by formula (11b) obtained in Step (b-1) with a halogen-containing alkyl alcohol and/or a halogen-containing alkyl thiol.

In these production methods, the halogen-containing alkyl alcohol and the halogen-containing alkyl thiol constitute an —X²R² group in formula (9) (in the case of halogen-containing alkyl alcohol, X²=O; in the case of a halogen-containing alkyl thiol, X²=S). Preferable configurations such as the halogen atom in the halogen-containing alkyl alcohol and the halogen-containing alkyl thiol, and the number of carbon atoms therein, are defined as in R¹.

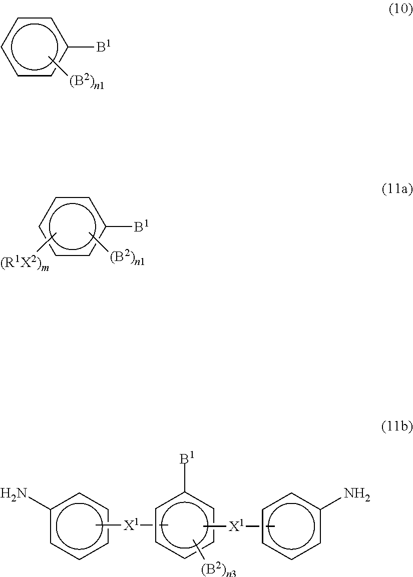

In formulas (10), (11a), and (11b), B¹, B², R¹, X¹, X², and m are defined as in formula (9); n1 represents the number of B²s in the compound represented by formula (10), and is 5; n2 represents the number of B²s in the compound represented by formula (11a), and is an integer of 2 to 4; and n3 represents the number of B²s in the compound represented by formula (11b), and is 3.

In Reaction Step (a-1) of Production Method (a), the reaction molar ratio between the halogen-containing alkyl alcohol and/or the halogen-containing alkyl thiol, and the compound represented by formula (10) is preferably set so that the total amount of the halogen-containing alkyl alcohol and the halogen-containing alkyl thiol is 0.3 to 10 mol for 1 mol of the compound represented by formula (10). Thereby, the compound supplied for the reaction in Reaction Step (a-2) can be obtained at high yield while generation of by-products is sufficiently reduced.

The molar ratio of the put substances is preferably adjusted depending on the target compound (in other words, the diamine compound represented by formula (9) to be obtained is a diamine compound having one halogen-substituted alkoxy group or halogen-substituted alkylthio group represented by R¹X², a diamine compound having two such groups, or a diamine compound having three such groups). In the case that a mono-substituted product (a diamine compound having one halogen-substituted alkoxy group or halogen-substituted alkylthio group) is to be produced, for example, the reaction is preferably performed in such a manner that the total amount of the halogen-containing alkyl alcohol and the halogen-containing alkyl thiol is 0.3 to 2 mol, and more preferably 0.5 to 1.5 mol, for 1 mol of the compound represented by formula (10). Similarly, in the case that a di-substituted product (a diamine compound having two halogen-substituted alkoxy group(s) and/or halogen-substituted alkylthio group(s)) is to be produced, the reaction is preferably performed in such a manner that the total amount of the halogen-containing alkyl alcohol and the halogen-containing alkyl thiol is 1 to 3 mol, and more preferably 1.5 to 2.5 mol. Similarly, in the case that a tri-substituted product (a diamine compound having three halogen-substituted alkoxy group(s) and/or halogen-substituted alkylthio group(s)), the reaction is preferably performed in such a manner that the total amount of the halogen-containing alkyl alcohol and the halogen-containing alkyl thiol is 2 to 10 mol, and more preferably 3 to 8 mol.

Reaction Step (a-1) is preferably performed in a solvent. For example, the solvent to be used may include one or more of polar solvents such as acetonitrile, N-methylpyrrolidone (NMP), N-methyl-2-pyrrolidinone, dimethylacetamide (DMAc), dimethyl formamide (DMF), dimethyl sulfoxide (DMSO), nitrobenzene, nitromethane, acetone, methylethyl ketone, and methylisobutyl ketone, and non-polar solvents such as toluene and xylene.

The amount of the solvent is not particularly limited as long as the reaction efficiently proceeds. For example, the amount is preferably adjusted such that the concentration of the compound represented by formula (10) is 3 to 40% by mass in the solvent. The concentration is more preferably 5 to 30% by mass.

Reaction Step (a-1) is also preferably performed in the presence of a catalyst. Preferable examples of the catalyst include basic catalysts. The basic catalyst is preferably a basic substance capable of capturing hydrogen halides (e.g. HF) which may be generated in the reaction, and examples of the catalyst to be used may include one or more of potassium carbonate, calcium carbonate, sodium carbonate, sodium fluoride, sodium hydroxide, potassium hydroxide, calcium hydroxide, potassium fluoride, triethylamine, tributylamine, and pyridine.

The amount of the catalyst is not particularly limited as long as the reaction efficiently proceeds. For example, the amount is preferably 0.3 to 10 mol for 1 mol in total of the halogen-containing alkyl alcohol and the halogen-containing alkyl thiol. The amount is more preferably 0.5 to 8 mol.

The reaction conditions of Reaction Step (a-1) are not particularly limited, and may be appropriately adjusted depending on the types and amounts of material compounds, and various other conditions. For example, the reaction temperature is preferably −20° C. to 200° C., and more preferably 0° C. to 150° C. Further, the reaction time is preferably 1 hour or longer, and more preferably 2 to 72 hours. The reaction under these conditions provides the compound represented by formula (11a) at high yield. Reaction Step (a-1) may be performed under normal pressure or may be performed under a pressurized state.

Reaction Step (a-1) appropriately provides the compound represented by formula (11a). This compound represented by formula (11a) is a compound to be reacted with an aminophenol and/or an aminothiophenol in Reaction Step (a-2).

In Reaction Step (a-2), the reaction molar ratio between the compound represented by formula (11a) and an aminophenol and/or an aminothiophenol is preferably adjusted in such a manner that the total amount of the aminophenol and the aminothiophenol is 2 mol or more for 1 mol of the compound represented by formula (11a), for example. The amount is more preferably 2 to 10 mol. Thereby, the target product (the diamine compound represented by formula (9)) can be obtained at high yield while generation of by-products is sufficiently reduced. The amount is further preferably 2 to 5 mol.

Reaction Step (a-2) is preferably performed in the presence of a catalyst and a solvent, similarly to Reaction Step (a-1), and the specific embodiments and preferable embodiments are as mentioned above. Here, the amount of the catalyst in Reaction Step (a-2) is preferably 0.5 to 10 mol, and more preferably 0.5 to 5 mol, for 1 mol of the compound represented by formula (11a), for example. The amount of the solvent is preferably adjusted in such a manner that the concentration of the compound represented by formula (11a) is 1 to 40% by mass in the solvent, for example. The concentration is more preferably 3 to 30% by mass.

The reaction conditions of Reaction Step (a-2) are not particularly limited, and may be appropriately adjusted depending on the types and amounts of material compounds, and various other conditions. For example, the reaction temperature is preferably −20° C. to 200° C., and more preferably 0° C. to 150° C. The reaction time is preferably 1 hour or longer, and more preferably 2 to 72 hours. The reaction under these conditions can provide the target product (the diamine compound represented by formula (9)) at high yield. Further, Reaction Step (a-2) may be performed under normal pressure or may be performed under a pressurized state.

In Production Method (a), steps other than the above reaction are not particularly limited. For example, the reaction product and the other components may be separated after termination of Reaction Step (a-1) by cooling down the product as appropriate, removing precipitated salts, distill-removing the solvent, and then distilling the product, or after the solvent removal, extracting the product using an organic solvent, and then carrying out column chromatography. Alternatively, the reaction product may be supplied to Reaction Step (a-2) as it is after the termination of Reaction Step (a-1). Also, after termination of Reaction Step (a-2), the reaction product and the other components may be separated by cooling down the product as appropriate, removing precipitated salts, distill-removing the solvent, and then distilling the product, or after the solvent removal, extracting the product using an organic solvent, and then carrying out column chromatography. Alternatively, other commonly performed purification methods such as recrystallization, reprecipitation, and sublimation purification may be performed.

In Reaction Step (b-1) of Production Method (b), the reaction molar ratio between the aminophenol and/or the aminothiophenol and the compound represented by formula (10) is preferably adjusted in such a manner that the total amount of the aminophenol and the aminothiophenol is 2 mol or more for 1 mol of the compound represented by formula (10). The amount is more preferably 2 to 10 mol. Thereby, the compound supplied to the reaction in Reaction Step (b-2) can be produced at high yield while generation of by-products is sufficiently reduced. The amount is further preferably 2 to 5 mol.

Reaction Step (b-1) is preferably performed in the presence of a catalyst and a solvent, similarly to Reaction Step (a-2), and the specific embodiments and preferable embodiments are as mentioned above. The amount of the catalyst in Reaction Step (b-1) is preferably 0.5 to 10 mol, and more preferably 0.5 to 5 mol, for 1 mol of the compound represented by formula (10), for example. The amount of the solvent is preferably adjusted in such a manner that the concentration of the compound represented by formula (10) is 1 to 40% by mass in the solvent, for example. The concentration is more preferably 3 to 30% by mass.

The reaction conditions in Reaction Step (b-1) are not particularly limited, and may be appropriately adjusted depending on the types and amounts of material compounds, and various other conditions. For example, the reaction temperature and the reaction time are preferably adjusted similarly to those mentioned in Reaction Step (a-2). Further, the reaction may be performed under normal pressure or may be performed under a pressurized state.

Reaction Step (b-1) appropriately provides the compound represented by formula (11b). The compound represented by formula (11b) is a compound to be reacted with a halogen-containing alkyl alcohol and/or a halogen-containing alkyl thiol in Reaction Step (b-2).

In Reaction Step (b-2), The reaction molar ratio between the compound represented by formula (11b) and the halogen-containing alkyl alcohol and/or the halogen-containing alkyl thiol is preferably adjusted in such a manner that the total amount of the halogen-containing alkyl alcohol and the halogen-containing alkyl thiol is 0.3 to 10 mol for 1 mol of the compound represented by formula (11b). Thereby, the target substance (the diamine compound represented by formula (9)) can be obtained at high yield while generation of by-products is sufficiently reduced.

The molar ratio between the put substances is preferably adjusted depending on the target compound (in other words, the diamine compound represented by formula (9) to be obtained is a diamine compound having one halogen-substituted alkoxy group or halogen-substituted alkylthio group represented by R¹X², a diamine compound having two such groups, or a diamine compound having three such groups). For example, in the case that a mono-substituted product is to be produced, the reaction is preferably performed in such a manner that the total amount of the halogen-containing alkyl alcohol and the halogen-containing alkyl thiol is 0.3 to 2 mol, and more preferably 0.5 to 1.5 mol, for 1 mol of the compound represented by formula (11a). Similarly, in the case that a di-substituted product is to be produced, the reaction is preferably performed in such a manner that the total amount of the halogen-containing alkyl alcohol and the halogen-containing alkyl thiol is 1 to 3 mol, and more preferably 1.5 to 2.5 mol. Similarly, in the case that a tri-substituted product is to be produced, the reaction is preferably performed in such a manner that the total amount of the halogen-containing alkyl alcohol and the halogen-containing alkyl thiol is 2 to 10 mol, and more preferably 3 to 8 mol.

Reaction Step (b-2) is also preferably performed in the presence of a catalyst and a solvent, similarly to Reaction Step (a-1), and the specific embodiments and preferable embodiments are as mentioned above. The amount of the catalyst in Reaction Step (b-2) is preferably 0.3 to 10 mol for 1 mol in total of the halogen-containing alkyl alcohol and the halogen-containing alkyl thiol, for example. The amount is more preferably 0.5 to 8 mol. The amount of the solvent is preferably adjusted in such a manner that the concentration of the compound represented by formula (11a) is 1 to 40% by mass in the solvent. The concentration is more preferably 3 to 30% by mass.

The reaction conditions of Reaction Step (b-2) are not particularly limited, and may be appropriately adjusted depending on the types and amounts of material compounds, and various other conditions. For example, the reaction temperature and the reaction time are preferably adjusted as mentioned in Reaction Step (a-1). Further, the reaction may be performed under normal pressure or may be performed under a pressurized state.

In Production Method (b), steps other than the above reactions are not particularly limited. For example, the separation and purification steps mentioned in Production Method (a) are preferably performed.

In the case that the diamine compound used as the material has the structure of formula (9) as the second preferable embodiment of the polyamic acid of the present invention, the product has flexibility and is excellent in physical properties such as hygroscopic resistance and water repellency. Alternatively, the diamine compound with the following structure can also exert the effects of the present invention.

In other words, in Production Methods (a) and (b), the diamine compound obtainable from a compound having two or more benzene rings and an amino group (—NH₂) and hydroxy group (—OH), such as biphenyl and biphenyl ether, instead of an aminophenol and/or an aminothiophenol, specifically, the diamine compound having a structure in which either or both of the two benzene rings at both ends in formula (9) is/are two or more benzene rings derived from the compound having two or more benzene rings and an amino group and hydroxy group, is also one preferable embodiment of the present invention.

The acid dianhydride used in the second preferable embodiment of the polyamic acid of the present invention is a compound represented by formula (12):

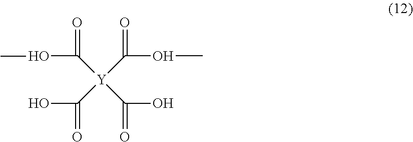

wherein Y represents a tetravalent organic group. Examples of the organic group represented by Y include aliphatic organic groups which may include a straight chain or a branched chain, or a ring; aromatic organic groups; organic groups wherein two or more aliphatic groups and/or aromatic groups bonded via a carbon atom; and organic groups wherein two or more aliphatic groups and/or an aromatic groups are bonded via an atom other than a carbon atom (e.g. oxygen atom, nitrogen atom, and sulfur atom). Particularly preferable are groups having a benzene ring, and also preferable are those having a halogen atom and/or a halogen-substituted alkyl group. Thereby, a polyimide excellent in various physical properties such as heat resistance, chemical resistance, water repellency, dielectricity, electrical properties, and optical properties is likely to be easily produced. Preferable embodiments of the halogen-substituted alkyl group and the halogen atom are as mentioned in formula (9).

The acid dianhydride is not specifically limited, and both aromatic and aliphatic compounds may be used. Further, two or more types of acid dianhydrides may be used in admixture.

Preferable examples of the aromatic tetracarboxylic anhydrides include the following compounds. pyromellitic dianhydride, 3,3′,4,4′-benzophenonetetracarboxylic dianhydride, 3,3′,4,4′-biphenylsulfone tetracarboxylic dianhydride, 3,3′,4,4′-tetracarboxydiphenyl methanoic dianhydride, 1,4,5,8-naphthalene tetracarboxylic dianhydride, 1,2,5,6-naphthalene tetracarboxylic dianhydride, 2,3,6,7-naphthalene tetracarboxylic dianhydride, 2,6-dichloronaphthalene-1,4,5,8-tetracarboxylic dianhydride, 2,7-dichloronaphthalene-1,4,5,8-tetracarboxylic dianhydride, 2,3,6,7-tetrachloronaphthalene-1,4,5,8-tetracarboxylic dianhydride, 3,3′,4,4′-biphenylether tetracarboxylic dianhydride, 2,3′,3,4′-biphenylether tetracarboxylic dianhydride, 1,2,3,4-furane tetracarboxylic dianhydride, 2,3,4,5-thiophenetetracarboxylic dianhydride, 4,4′-bis(3,4-dicarboxyphenoxy)diphenyl sulfide dianhydride, 4,4′-bis(3,4-dicarboxyphenoxy)diphenyl sulfone dianhydride, 4,4′-bis(3,4-dicarboxyphenoxy)diphenyl propane dianhydride, 3,3′,4,4′-biphenyltetracarboxylic dianhydride, bis(phthalic acid)phenylphosphine oxide dianhydride, 3,3′,4,4′-perfluoroisopropylidene diphthalic dianhydride, 2,2-bis(3,4-dicarboxyphenyl)hexafluoropropane dianhydride, 2,2-bis(3,4-dicarboxyphenyl)propane dianhydride, difluoropyromellitic dianhydride, dichloropyromellitic dianhydride, trifluoromethylpyromellitic dianhydride, 1,4-di(trifluoromethyl)pyromellitic dianhydride, di(heptafluoropropyl)pyromellitic dianhydride, pentafluoroethyl pyromellitic dianhydride, bis(3,5-di(trifluoromethyl)phenoxy)pyromellitic dianhydride, 5,5′-bis(trifluoromethyl)-3,3′,4,4′-tetracarboxybiphenyl acid dianhydride, 1,2′,5,5′-tetrakis(trifluoromethyl)-3,3′,4,4′-tetracarboxybiphenyl acid dianhydride, 5,5′-bis(trifluoromethyl)-3,3′,4,4′-tetracarbon diphenyl ether acid dianhydride, 5,5′-bis(trifluoromethyl)-3,3′,4,4′-tetracarboxybenzophenolic dianhydride, 3,4,9,10-tetracarboxyperylenic dianhydride, 1,4-bis(3,4-dicarboxytrifluorophenoxy)tetrafluorobenzoic dianhydride, 1,4-bis(3,4-dicarboxytrifluorophenoxy)tetrachlorobenzoic dianhydride, 1,4-bis(3,4-dicarboxytrifluorophenoxy)octafluorobiphenyl acid dianhydride, 3,3′,4,4′-dimethyldiphenylsilane tetracarboxylic dianhydride, 3,3′,4,4′-tetraphenylsilane tetracarboxylic dianhydride, and 1,3-bis(3,4-dicarboxyphenyl)tetramethyldisiloxane acid dianhydride.

Preferable examples of the aliphatic tetracarboxylic dianhydride include the following compounds.

Aliphatic or alicyclic tetracarboxylic dianhydrides such as butanetetracarboxylic dianhydride, 1,2,3,4-cyclobutane tetracarboxylic dianhydride, 1,3-dimethyl-1,2,3,4-cyclobutane tetracarboxylic acid, 1,2,3,4-cyclopentane tetracarboxylic dianhydride, 2,3,5-tricarboxycyclopentylacetic dianhydride, 3,5,6-tricarboxynorbornane-2-acetic dianhydride, 2,3,4,5-tetrahydrofurane tetracarboxylic dianhydride, 5-(2,5-dioxotetrahydrofural)-3-methyl-3-cyclohexene-1,2-dicarboxylic dianhydride, and bicyclo[2,2,2]-oct-7-ene-2,3,5,6-tetracarboxylic dianhydride; 1,3,3a,4,5,9b-hexahydro-2,5-dioxo-3-furanyl)-naphth[1,2-c]furane-1,3-dione, 1,3,3a.4,5,9b-hexahydro-5-methyl-5-(tetrahydro-2,5-dioxo-3-furanyl)-naphth[1,2-c]furane-1,3-dione, and 1,3,3a,4,5,9b-hexahydro-8-methyl-5-(tetrahydro-2,5-dioxo-3-furanyl)-naphth[1,2-c]furane-1,3-dione.

Preferable among the above acid dianhydrides are aromatic tetracarboxylic anhydrides. Examples of the aromatic tetracarboxylic anhydrides are those in an embodiment wherein the organic group represented by Y in formula (12) is a group represented by formulas (13-1) to (13-3)

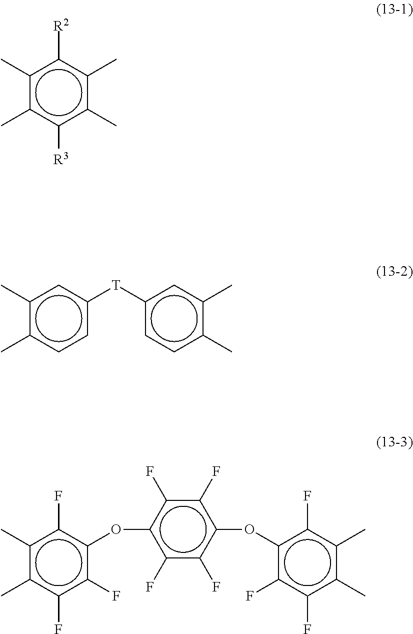

wherein R² and R³ are the same as or different from each other, and each represent a hydrogen atom (H), halogen atom, or halogen-substituted alkyl group; T is a group or a structure represented by the following formula wherein R⁴ and R⁵ are the same as or different from each other, and each represent a hydrogen atom (H), halogen atom, or halogen-substituted alkyl group.

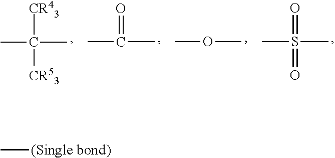

Preferable among the above aromatic tetracarboxylic anhydrides are 3,3′,4,4′-biphenylether tetracarboxylic dianhydride, 2,3′,3,4′-biphenylether tetracarboxylic dianhydride, 4,4′-bis(3,4-dicarboxyphenoxy)diphenyl sulfide dianhydride, 4,4′-bis(3,4-dicarboxyphenoxy)diphenyl sulfone dianhydride, 4,4′-bis(3,4-dicarboxyphenoxy)diphenyl propane dianhydride, 2,2-bis(3,4-dicarboxyphenyl)hexafluoropropane dianhydride, 2,2-bis(3,4-dicarboxyphenyl)propanoic dianhydride, 5,5′-bis(trifluoromethyl)-3,3′,4,4′-tetracarbon diphenyl ether acid dianhydride, 1,4-bis(3,4-dicarboxytrifluorophenoxy)tetrafluorobenzoic dianhydride, 1,4-bis(3,4-dicarboxytrifluorophenoxy)tetrachlorobenzoic dianhydride, and 1,4-bis(3,4-dicarboxytrifluorophenoxy)octafluorobiphenyl acid dianhydride. More preferable are 1,4-bis(3,4-dicarboxytrifluorophenoxy)tetrafluorobenzoic dianhydride represented by formula (14) and/or 2,2-bis(3,4-dicarboxyphenyl)hexafluoropropane dianhydride represented by formula (15). The polyamic acid having a structure derived from these acid dianhydrides can provide a polyimide having much better properties such as solubility to an organic solvent, heat resistance, hygroscopic resistance, water repellency, and mold releasability. As mentioned above, an embodiment wherein the acid dianhydride is the compound represented by formulas (14) and/or (15) is also one preferable embodiment of the present invention.

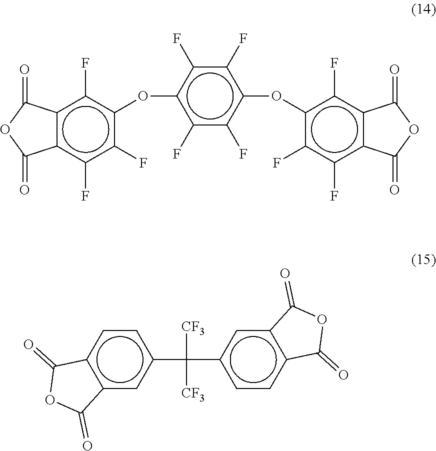

The reaction step between the acid dianhydride and the diamine compound in the second preferable embodiment of the polyamic acid of the present invention can be performed in the same manner as in the first preferable embodiment of the polyamic acid of the present invention.

The polyamic acid of the second preferable embodiment can be mentioned as one having a repeating unit represented by formula (16):

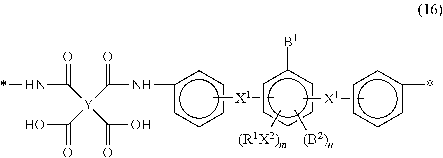

wherein Y represents a tetravalent organic group; B¹ represents CF₃ or CN; B²s are the same as or different from each other, and each represent H, F, Cl, Br, or I; R¹ represents a C1-C20 halogen-substituted alkyl group; X¹s are the same as or different from each other, and each represent O or S; X² represents O or S; n represents the number of B²s, and is an integer of 0 to 2; m represents the number of substitutions in the group represented by R¹X², and is an integer of 1 to 3; and n+m=3. Such a polyamic acid has a structure derived from the diamine compound represented by formula (9). Thus, it is useful as a material which provides a polyimide excellent in various physical properties such as heat resistance, chemical resistance, dielectricity, electrical properties, and optical properties, and extremely excellent in water repellency. As mentioned above, an embodiment wherein the polyamic acid in the present invention has a repeating unit represented by formula (16) is also one preferable embodiment of the present invention.

The polyamic acid in the second preferable embodiment may be synthesized using at least the diamine compound represented by formula (9) and the acid dianhydride represented by formula (12). A commonly used general diamine compound may be used in combination, that is, may be copolymerized, within the range where the characteristics of the diamine compound represented by formula (9) are sufficiently exerted. In other words, the polyamic acid in the second preferable embodiment may be one obtainable by copolymerizing the diamine compound represented by formula (9), a commonly used general diamine compound, and the acid dianhydride represented by formula (12). Assuming that the total amount of all the diamine compounds is 100 mol %, the amount of the diamine compound represented by formula (9) is preferably 5 mol % or more. The amount is more preferably 25 mol % or more, further preferably 50 mol % or more, and most preferably 100 mol %.

More preferable embodiment of the polyamic acid in the second preferable embodiment can be obtained by synthesizing the diamine compound represented by formula (9) and the acid dianhydride represented by formula (12) each in a more preferable embodiment. In other words, an embodiment wherein the polyamic acid of the present invention has a structure in which R¹ in formula (16) is a C1-C20 fluorine-substituted alkyl group and an embodiment wherein the polyamic acid of the present invention has a structure in which B² in formula (16) is F (fluorine atom) are also preferable embodiments of the present invention.

In the third preferable embodiment of the polyamic acid of the present invention, the acid dianhydride used as a material is preferably 4,4′-[(2,3,5,6-tetrafluoro-1,4-phenylene)bis(oxy)]bis(3,5,6-trifluorophthalic anhydride) represented by formula (17).

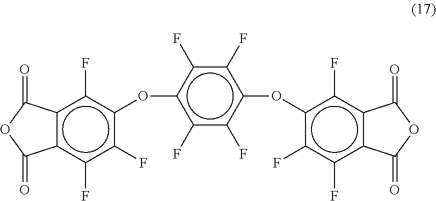

Since the polyamic acid in the third preferable embodiment has a structure derived from the compound represented by formula (17), it is excellent in properties such as solubility to an organic solvent, heat resistance, hygroscopic resistance, water repellency, and mold releasability.

The diamine compound used in the third preferable embodiment of the polyamic acid of the present invention can be the same diamine compound as in the first preferable embodiment of the polyamic acid of the present invention.

In the polymerization reaction step for producing the polyamic acid of the third preferable embodiment, the blending ratio of the materials is preferably adjusted in such a manner that the amount of the diamine compound is 0.01 to 3 mol for 1 mol of 4,4′-[(2,3,5,6-tetrafluoro-1,4-phenylene)bis(oxy)]bis(3,5,6-trifluorophthalic anhydride). Thereby, a polyamic acid (and a polyamic acid composition) having much better properties such as heat resistance and hygroscopic resistance can be obtained. The amount of the diamine compound is more preferably 0.5 to 2 mol. Other conditions for the polymerization reaction step can be the same as those for the polymerization reaction step for producing the polyamic acid in the first preferable embodiment of the present invention.

The polyamic acid in the third preferable embodiment can be represented as one having a repeating unit represented by formula (18):

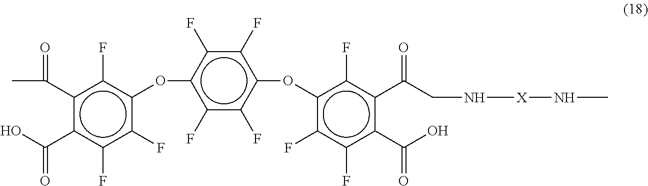

wherein X represents a divalent organic group. Such a polyamic acid has a structure derived from the compound represented by formula (17), and thus has excellent properties such as solubility to an organic solvent, heat resistance, hygroscopic resistance, water repellency, and mold releasability. As mentioned above, an embodiment wherein the polyamic acid of the present invention has a repeating unit represented by formula (18) is also one preferable embodiment of the present invention.

A polyamic acid composition containing the polyamic acid of the present invention is also one aspect of the present invention. If such a polyamic acid composition contains much water, especially in the case of using a high molecular weight polyamic acid having a weight average molecular weight of 200,000 or more as a polyamic acid, the polyamic acid may be depolymerized and the molecular weight of the polyamic acid may decrease. Further, in the case of producing a polyimide film, the above problem may cause insufficient flexibility of the polyimide film, and thus it may be impossible to take out the product as a film. Therefore, in the case of using a high molecular weight polyamic acid having a weight average molecular weight of 200,000 or higher as a polyamic acid, the water content in the polyamic acid composition (or the polyamic acid) is preferably 1,000 ppm or less.

The polyamic acid composition may further contain components other than the polyamic acid (other components) depending on a desired use. Examples of the other components include various additives such as carbon black, fluororesin, dispersants, organic solvents, inorganic fillers, mold-release agents, coupling agents, and flame retardants. The polyamic acid composition preferably contains at least one of carbon black and fluororesin. As mentioned above, a polyamic acid composition containing carbon black and/or fluororesin in addition to the polyamic acid is also one preferable embodiment of the present invention. In this composition, the carbon black and/or the fluororesin are/is preferably in a state of being dispersed in the composition.

Also in such a composition, the water content is preferably 1,000 ppm or less in the case of using a high molecular weight polyamic acid having a weight average molecular weight of 200,000 or higher as the polyamic acid. As mentioned below, however, no water is preferably mixed even in the case that the carbon black and/or the fluororesin are/is mixed as dispersions after polymerization of the polyamic acid.

Examples of the carbon black include, but not limited to, commercially available conductive carbon black. Specific examples thereof include furnace black produced by continuously pyrolyzing a gaseous or liquid material in a furnace, in particular, ketjen black produced from ethylene heavy oil as a material, channel black produced by burning a material gas and making the fire in contact with the bottom of a channel steel so that the material is quenched and precipitated, and thermal black produced from a gas as a material and by periodically repeating burning and pyrolyzing the material, in particular acetylene black produced from acetylene gas as a material. In addition, carbon nanotube may be used. Particularly preferable are ketjen black, acetylene black, and carbon nanotube whose crystallite and structure are highly developed. They may be used alone, or two or more of these may be used in admixture.

The fluororesin is not particularly limited as long as it is a polymer having a structural unit derived from olefin (fluoroolefin) containing a fluorine atom. Examples of the fluoroolefin include vinylidene fluoride (PVDF), hexafluoropropylene, and tetrafluoroethylene. Preferable examples of the fluororesin include polytetrafluoroethylene (PTFE), a tetrafluoroethylene-perfluoroalkoxyethylene copolymer (PFA), tetrafluoroethylene-hexafluoropropylene resin (FEP), a tetrafluoroethylene-ethylene copolymer (ETFE), chlorotrifluoroethylene resin (PCTFE), a chlorotrifluoroethylene-ethylene copolymer (ECTFE), cyclic perfluoropolymers, and vinyl fluoride resin (PVF). One or more of these may be used.

In the polyamic acid composition containing carbon black and/or fluororesin, the mass ratio between the polyamic acid and the carbon black and/or the fluororesin may be appropriately determined depending on a desired surface resistance and water repellency. For example, the total amount (solids content) of the carbon black and the fluororesin is preferably 0.5 to 50 parts by weight for 100 parts by weight of the polyamic acid (solids content). If the amount is less than 0.5 parts by weight, sufficient water repellency and mold releasability may not be achieved, and the surface resistance value may not be controlled. If the amount is more than 50 parts by weight, the mechanical strength may not be further improved. The amount is more preferably 1 to 40 parts by weight, and further preferably 1 to 30 parts by weight. The amount is particularly preferably 2 to 20 parts by weight.

As mentioned above, in the polyamic acid composition containing carbon black and/or fluororesin, the carbon black and/or the fluororesin are/is preferably in a state of being dispersed in the composition. In the present invention, use of the polyamic acid in the above embodiments allows the carbon black and/or the fluororesin to be uniformly dispersed in the composition. Thus, the product is not only excellent in properties such as heat resistance and water repellency, but also has sufficiently less varied surface resistance value (electric resistance value). In the case that the product is used for a belt for image-forming and image-recording devices, for example, occurrence of unevenness and the like is suppressed, and good images can be printed and fixed.

Examples of the method for preparing such a polyamic acid composition containing carbon black and/or fluororesin include (I) a method in which an acid dianhydride and a diamine compound, the materials of the polyamic acid, are polymerized in the presence of carbon black and/or fluororesin, and (II) a method in which an acid dianhydride and a diamine compound, the materials of the polyamic acid, are polymerized to provide a polyamic acid, and then this polyamic acid and carbon black and/or fluororesin are mixed with each other.

In the preparation method, the carbon black and/or the fluororesin may be used as a dispersion wherein the substances are dispersed in an organic solvent, if necessary. For example, a dispersion with carbon black and/or fluororesin dispersed in an organic solvent is preferably used in the polymerization reaction step in the method (I), or in the mixing step with the polyamic acid in the method (II). The organic solvent is not particularly limited as long as carbon black and fluororesin are dispersed or dissolved. For example, an organic solvent which can be used in the below-mentioned polymerization reaction step can be suitably used. Upon dispersing carbon black in an organic solvent or upon directly mixing carbon black with a polyamic acid, a dispersant is preferably used. The dispersant is not particularly limited, and examples thereof include anionic, nonionic, and cationic surfactants, and high-molecular dispersants. One or more of these can be used. In particular, a high-molecular dispersant is preferably used because of its dispersing property.

Preferable examples of the high-molecular dispersant include polycarboxylic acid high-molecular dispersants having multiple carboxyl groups in the molecule, polyamine high-molecular dispersants having multiple amino groups in the molecule, high-molecular dispersants having multiple amide groups in the molecule, and high-molecular dispersants having multiple polycyclic aromatic compounds in the molecule. One or more of these can be used.

Examples of the polycarboxylic acid high-molecular dispersant include copolymers of (meth)acrylic acid and a (meth)acrylic acid ester, amidized or esterified products of a maleic anhydride copolymer and an amine such as an alkylamine or an alcohol, and comb-shaped polymers wherein a polyester of polycarboxylic acid such as a poly(meth)acrylic acid copolymer and polyalkylene glycol are grafted. The term “(meth)acrylic acid” herein means acrylic acid or methacrylic acid.

Examples of the polyamine high-molecular dispersant include comb-shaped polymers wherein polyester is grafted to polyamine such as polyalkyleneamine, polyallylamine, and N,N-dimethylaminoethyl methacrylate.

Examples of the high-molecular dispersant having multiple amide groups in the molecule include copolymers of polyamide, polyvinylpyrrolidone, poly N,N-dimethylacrylamide obtained by condensation reaction, and comb-shaped polymers with polyester and polyalkylene glycol grafted to these copolymers.

Examples of the high-molecular dispersant having polycyclic aromatic compounds include copolymers of vinyl monomers having a pyrene or quinacridone skeleton and various monomers.

In the case of using the above dispersant, the amount of the dispersant is preferably 0.1 to 20 parts by weight for 100 parts by weight of a matter in which the substances are dispersed (polyamic acid composition) for the purpose of suitably performing dispersion. The amount is more preferably 0.5 to 10 parts by weight.

The polymerization reaction step for obtaining a polyamic acid in the preparation method is as mentioned above. In the case of dispersing carbon black and/or fluororesin in an organic solvent and performing a polymerization reaction in the presence of the dispersion, an organic solvent may be further added during the polymerization reaction, or the organic solvent in the dispersion may be used as a polymerization solvent. In this case, the amount of the organic solvent in the polymerization reaction step is preferably adjusted such that the total amount thereof, including the organic solvent in the dispersion of carbon black and/or fluororesin, is within the above-mentioned range of the organic solvent.

As mentioned above, the polyamic acid and the polyamic acid composition are excellent in properties such as heat resistance, hygroscopic resistance, water repellency, mold releasability (detachability), durability (mechanical strength), dielectricity, and electrical properties. Thus, the polyimide produced from these substances as the materials can be preferably applied to various uses such as electric and electronic components, machine components, and optical components. Such polyimide is especially useful for copier member uses (use as belts for image-forming and image-recording devices) and, for example, can be suitably used as transfer belts and fixing belts (belt-shaped sheets and films), as well as coating films for inkjet-printing printer heads, semiconductor gate insulating films, and wetproof and dampproof insulating materials for electronic and electric devices and components. As mentioned above, an embodiment wherein the polyamic acid composition is a composition for forming belts for image-forming and image-recording devices is also one preferable embodiment of the present invention. In addition, such a polyamic acid and polyamic acid composition are excellent in heat resistance, water repellency, mold releasability, and durability (e.g. mechanical strength), and can provide a polyimide composition with a sufficiently less varied electric resistance value. Thus, they can provide copier members (e.g. belts for image-forming and image-recording devices) excellent in properties such as a fixing property, printability, and mold releasability, and high in durability, without occurrence of problems such as unevenness. Furthermore, use of such a belt enables to stably and continuously form and record images. In particular, the polyamic acid in the third preferable embodiment of the present invention and the polyamic acid composition containing it are excellent in the above various physical properties and can provide a polyimide composition with controllable surface resistance. As mentioned above, the polyamic acid composition comprising a polyamic acid having the repeating unit represented by formula (18) and carbon black and/or fluororesin is also one preferable embodiment of the present invention.

The polyimide and the polyimide composition of the present invention can be obtained by imidizing the polyamic acid and the polyamic acid composition of the present invention. The polyimide obtained by imidizing the polyamide of the present invention is one preferable embodiment of the polyimide of the present invention, and the polyimide composition obtained by imidizing the polyamic acid composition of the present invention is also one aspect of the present invention. As one example of the polyimide, the polyimide obtained by imidizing the polyamic acid in the second preferable embodiment of the present invention is also represented as a polyimide having a repeating unit represented by formula (19):

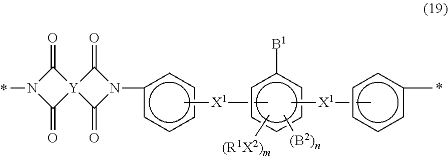

wherein Y represents a tetravalent organic group; B¹ represents CF₃ or CN; B²s are the same as or different from each other, and each represent H, F, Cl, Br, or I; R¹ represents a C1-C20 halogen-substituted alkyl group; X¹s are the same as or different from each other, and each represent O or S; X² represents O or S; n represents the number of B²s, and is an integer of 0 to 2; m represents the number of substitutions in the group represented by R¹X², and is an integer of 1 to 3; and n+m=3. As mentioned above, the polyimide of the present invention in a state of having a repeating unit represented by formula (19) is also one preferable embodiment of the present invention.

The present invention also relates to a polyimide composition containing the polyimide of the present invention.

In the present description, a substance obtained by imidizing a polyamic acid is referred to as a “polyimide”, and a substance obtained by imidizing a polyamic acid composition referred to as a “polyimide composition”.

The polyimide of the present invention may be a film or a sheet-shaped article, or may be a molded body. In order to make the polyimide more suitable for copier members, it is preferably a film-shaped article.

The imidization reaction may be performed by a common method. For example, the imidization may be achieved by heating and/or vacuum-drying these, or these may be chemically imidized by a commonly employed method.

In the chemical imidization step, use of a dehydrocyclization reagent is also preferable. The dehydrocyclization reagent to be used may be any reagent without limitation as long as it has an effect of chemically dehydrocyclizing a polyamic acid into a polyimide. Examples of such a dehydrocyclization reagent include tertiary amines such as trimethylamine, triethylamine, tripropylamine, tributylamine, pyridine, 1,4-diazabicyclo[2,2,2]octane (abbreviated as “DABCO”), 1,8-diazabicyclo[5,4,0]undec-7-ene, 1,5-diazabicyclo[4,3,0]non-5-ene, N,N,N′,N′-tetramethyldiaminomethane, N,N,N′,N′-tetramethylethylenediamine, N,N,N′,N′-tetramethyl-1,3-propanediamine, N,N,N′,N′-tetramethyl-1,4-phenylenediamine, N,N,N′,N′-tetramethyl-1,6-hexanediamine, N,N,N′,N′-tetraethylmethylenediamine, and N,N,N′,N′-tetraethylethylenediamine; and carboxylic anhydrides such as acetic anhydride, trifluoroacetic anhydride, propionic anhydride, butyric anhydride, isobutyric anhydride, succinic anhydride, and maleic anhydride. Preferable among the tertiary amines are pyridine, DABCO, and N,N,N′,N′-tetramethyldiaminomethane, and DABCO is particularly preferable. Preferable among the carboxylic anhydrides are acetic anhydride and trifluoroacetic anhydride, and acetic anhydride is more preferable. With respect to these tertiary amines and carboxylic anhydrides, a tertiary amine may be used alone, or a tertiary amine and a carboxylic anhydride may be used in combination.

In the case of performing imidization by heating and/or vacuum-drying, the heating treatment may be performed in an organic solvent or in the absence of an organic solvent. In consideration of reaction efficiency and the like, the heating is preferably performed in an organic solvent. In this case, the polyamic acid and the polyamic acid composition may be in a state of a solution obtained by the aforementioned reaction for preparing the polyamic acid, or may be heated after the polyamic acid or the polyamic acid composition are separated out as a solid, and then re-dissolved in an organic solvent. Preferable examples of the organic solvent include the aforementioned polar solvents and non-polar solvents, and one or more of these may be used.

The heating treatment step is preferably performed as follows, for example: the polyamic acid or the polyamic acid composition is applied to a substrate or a film, or the polyamic acid composition is charged in a mold, and then heated in the air (preferably, in the atmosphere of an inert gas such as nitrogen, helium, or argon) at a temperature of 70° C. to 400° C. The heating temperature is more preferably 250° C. to 350° C. The heating time is preferably 0.5 to 5 hours, and more preferably 1 to 2 hours. The heating treatment may be performed in a stepwise manner or may be in a continuous manner.

In general, the vacuum-drying treatment step is normally performed by normal-temperature cooling, or by heating, preferably under a reduced pressure of about 1.33×10⁻¹ Pa (1×10⁻¹ Torr) or higher and lower than 1.01×10⁶ Pa (760 Torr). The normal-temperature cooling or reduced-pressure drying time is preferably 2 to 24 hours, and the treatment may be performed in a continuous manner or may in a stepwise manner.

Examples of the method for applying the polyamic acid or the polyamic acid composition to a substrate or a film include common techniques such as casting, spin coating, roll coating, spray coating, bar coating, flexography, and dip coating.

The polyamic acid or the polyamic acid composition used in the heating treatment preferably has a solids concentration of 3 to 80% by mass. If the solids concentration is out of this range, the composition may not be uniformly developed upon the heating treatment, and the thickness may be uneven. The concentration is more preferably 5 to 60% by mass.

The thickness of the polyimide obtained as mentioned above is not particularly limited, and may be adjusted depending on its use. In the use as copier members (e.g. use as belts for image-forming and image-recording devices), the thickness is preferably 0.5 to 50 μm, and more preferably 1 to 30 μm.

The polyimide of the present invention is excellent particularly in water repellency because the acid dianhydride and/or the diamine compound as the materials thereof have the specific number of ether linkages and/or thioether linkages. The water repellency can be evaluated based on an angle of contact with water on its surface. For example, the angle of contact with water may be 70° or greater. The angle is more preferably 75° or greater, further preferably 80° or greater, particularly preferably 85° or greater, and most preferably 90° or greater. As mentioned above, an embodiment wherein the polyimide has a contact angle with water (also referred to as an angle of contact with water) of 90° or greater is also one preferable embodiment of the present invention. As a result, the polyimide can be suitably used particularly in the use as copier members.

The angle of contact with water can be measured using a contact angle meter “CA-X” (Kyowa Interface Science Co., Ltd).

The polyimide is also excellent in flexibility because the acid dianhydride and/or the diamine compound as the materials thereof have the specific number of ether linkages and/or thioether linkages. The flexibility can be evaluated based on a tensile modulus. For example, the tensile modulus may be 81 MPa or lower. As mentioned above, an embodiment wherein the polyimide has a tensile modulus of 81 MPa or lower is also one preferable embodiment of the present invention. As a result, the polyimide is much better used in the use as copier members. The tensile modulus is more preferably 30 MPa or lower, and further preferably 15 MPa or lower. The tensile modulus (MPa) can be measured by a dynamic viscoelasticity measurement method, as mentioned later.

### Effects of the Invention

The polyimide of the present invention has the aforementioned configuration, is inexpensive, is excellent in various physical properties such as strength, heat resistance, hygroscopic resistance, mold releasability (detachability), dielectricity, electrical properties, and optical properties, and can exert water repellency at high level. Further, specific polyimides of the present invention have not only excellent physical properties but also a controllable surface resistance value. Thus, these polyimides are extremely useful for copier uses; in particular, they are preferable for transfer belts and fixing belts, coating films for inkjet-printing printer heads, and the like.

### BRIEF DESCRIPTION OF THE DRAWINGS

FIG. 1 is a ¹H-NMR measurement chart of the mixture of pentafluorodecanoxy-2,3,5,6-tetrafluorobenzonitrile (p-substitution product) and pentafluorodecanoxy-3,4,5,6-tetrafluorobenzonitrile (o-substitution product) obtained in Synthesis Example 1.

FIG. 2 is a ¹⁹F-NMR measurement chart of the mixture of (p-substitution product) and pentafluorodecanoxy-3,4,5,6-tetrafluorobenzonitrile (o-substitution product) obtained in Synthesis Example 1.

### MODES FOR CARRYING OUT THE INVENTION

The present invention will be further described in detail referring to, but not limited to, examples. In the following examples and comparative examples, the contact angle by water was measured using a contact angle meter (Kyowa Interface Science Co., Ltd, CA-X). The surface resistance value was measured using a super megohm meter (digital megohm meter: DSM-8104, DKK-TOA Corporation). The elastic modulus (MPa) was measured by the following dynamic viscoelasticity measurement method, and the weight average molecular weight (Mw) of the polyamic acid was measured by the following GPC measurement method.

### <Dynamic Viscoelasticity Measurement Method>

Device: dynamic viscoelasticity RSA III, TA Instruments Japan Inc.

Measurement method: a 20-μm film was formed into a rectangle with a size of 5×40 mm, and the elongation and the stress were measured at 200° C., thereby calculating the tensile modulus.

### <GPC Measurement Method>

Device: HCL-8220GPC, TOSOH CORPORATION

Column: TSKgel Super AWM-H

Eluent (LiBr.H₂O, phosphoric acid-containing NMP): 0.01 mol/L

### Synthesis of heptadecafluorodecanoxytetrafluorobenzonitrile (17FD-TFBN)

### Synthesis Example 1

Pentafluorobenzonitrile (PFBN) (5.66 g, 29.31 mmol), an alkyl fluorinated alcohol (9.28 g, 19.99 mmol), potassium carbonate (1.45 g, 10.49 mmol), and acetonitrile (50 g) were put into a reaction vessel at once. This reaction solution was heated at 70° C. for 24 hours, and then cooled down. After the reaction termination, precipitated salts were filtered. The solvent was distilled off, and the obtained crude product was distilled under reduced pressure at a condition of 113 to 118° C./0.1 mmHg. Thereby, a white solid (8.92 g, yield: 70%) was obtained.

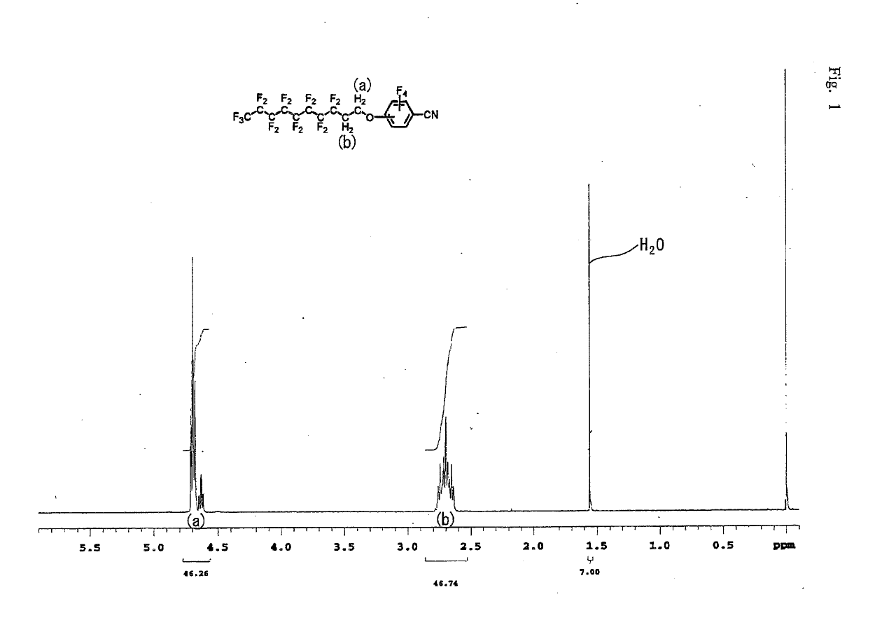

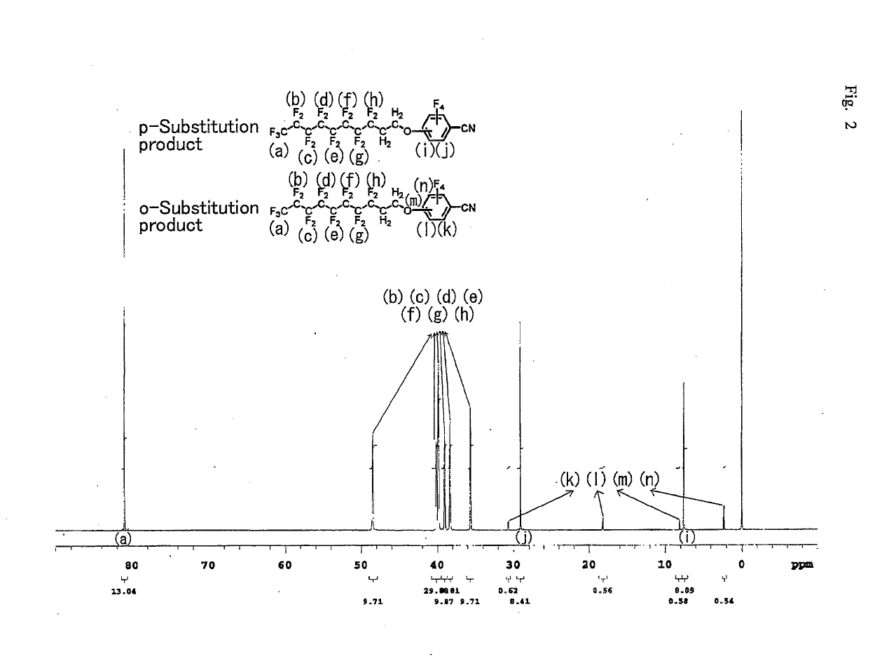

The obtained product was a mixture of pentafluorodecanoxy-2,3,5,6-tetrafluorobenzonitrile (p-substitution product)/pentafluorodecanoxy-3,4,5,6-tetrafluorobenzonitrile (o-substitution product) (=87.7/12.3). FIG. 1 and FIG. 2 show the ¹H-NMR and ¹⁹F-NMR charts of the obtained substance, respectively. The ratio between the p-substitution product/o-substitution product of the obtained product was calculated from the area ratio of the peaks (i), (j), and (k), (l), (m), and (n) in the ¹⁹F-NMR chart of FIG. 2. The measurements of ¹H-NMR and ¹⁹F-NMR were performed with the following device under the following conditions.

### [Measurement of ¹H-NMR and ¹⁹F-NMR]

¹H-NMR (400 MHz) and ¹⁹F-NMR (376 MHz) spectra were measured using Unity Plus 400 (Varian) and a CDCl₃ solvent, and the structure was analyzed. In the ¹H-NMR spectrum, the position of H of tetramethylsilane (TMS) as an internal standard was set to 0 ppm, and in the ¹⁹F-NMR spectrum, the position of F of hexafluorobenzene as an internal standard was set to 0 ppm.

The structure of heptadecafluorodecanoxy-2,3,5,6-tetrafluorobenzonitrile (p-substitution product) which is the main component obtained in Synthesis Example 1 is shown below.

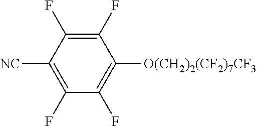

### Synthesis of Diamine Compound

### Synthesis Example 2

A 300-ml three-neck reaction vessel was charged with heptadecafluorodecanoxytetrafluorobenzonitrile (10.00 g, 15.69 mmol) obtained in Synthesis Example 1, p-aminophenol (5.13 g, 47.01 mmol), potassium carbonate (8.68 g, 62.80 mmol), and acetonitrile (150 g). The substances were heated up to 80° C. and reacted for 16 hours, and then the reaction product was allowed to cool down. The reaction solution was filtered so that inorganic salts were removed, and then concentrated using an evaporator. The concentrate was dissolved in ethyl acetate, and washed with water twice. The organic layer was dried over sodium sulfide and then concentrated. The concentrate was purified by silica gel column chromatography (ethyl acetate/hexane=7/3) and further recrystallized. Thereby, a target diamine compound (4.82 g, 5.91 mmol, yield: 38%) was obtained. The chemical equation in Synthesis Example 2 is shown below.

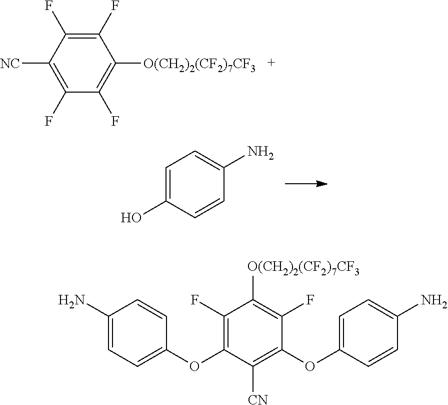

Further, the ¹H-NMR and the ¹⁹F-NMR of the obtained diamine compound were measured. The results are shown below. In the ¹H-NMR, tetramethylsilane was a standard substance, and in the ¹⁹F-NMR, hexafluorobenzene was a standard substance.

NMR spectra (device: JEOL Ltd., Type: JNM-AL 400)

¹H-NMR (CDCl₃): δ6.87 (dd, J=2.4 Hz, 6.8 Hz, 4H), δ6.64 (dd, J=2.4 Hz, 6.8 Hz, 4H), δ4.54 (t, J=6.8 Hz, 2H), δ3.58 (brs, 4H), δ2.67-2.58 (m, 2H)

¹⁹F-NMR (CDCl₃): δ81.01 (t, J=9.4 Hz, 3F), δ48.44 (t, J=15.79 Hz, 2F), δ40.10 (brs, 2F), δ39.84 (brs, 4F), δ39.04 (brs, 2F), δ38.25 (brs, 2F), δ35.65 (brs, 2F), δ16.70 (s, 2F)

### Synthesis Example 3

A 300-ml three-neck reaction vessel was charged with heptadecafluorodecanoxytetrafluorobenzonitrile (12.00 g, 18.83 mmol) obtained in Synthesis Example 1, 4-aminobenzenethiol (4.71 g, 37.62 mmol), potassium carbonate (7.8 g, 56.44 mmol), and acetonitrile (170 g). The substances were heated up to 40° C. and reacted for 14 hours, and then the reaction product was allowed to cool down. The reaction solution was filtered so that inorganic salts were removed, and then concentrated using an evaporator. The concentrate was dissolved in ethyl acetate, and washed with water twice. The organic layer was dried over sodium sulfide and concentrated. The concentrate was purified by silica gel column chromatography (ethyl acetate/hexane=7/3) and further recrystallized twice. Thereby, a target diamine compound (5.30 g, 6.25 mmol, yield: 33%) was obtained. The chemical equation in Synthesis Example 3 is shown below.

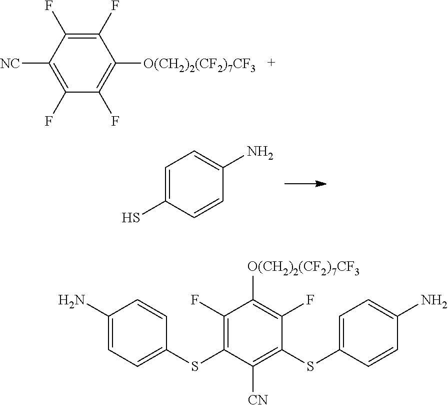

Further, the ¹H-NMR and the ¹⁹F-NMR of the obtained diamine compound were measured. The results are shown below. In the ¹H-NMR, tetramethylsilane was a standard substance, and in the ¹⁹F-NMR, hexafluorobenzene was a standard substance.

NMR spectrum (device: JEOL Ltd., Type: JNM-AL 400)

¹H-NMR (CDCl₃): δ7.38 (dd, J=2.0 Hz, 6.8 Hz, 4H), δ6.59 (dd, J=2.0 Hz, 6.8 Hz, 4H), δ4.44 (t, J=6.4 Hz, 2H), δ3.80 (brs, 4H), δ2.64-2.55 (m, 2H)

¹⁹F-NMR (CDCl₃): δ81.02 (t, J=9.4 Hz, 3F), δ84.43 (t, J=14.66 Hz, 3F), δ46.99 (s, 2F), δ40.11 (brs, 2F), δ39.86 (brs, 4F), δ39.05 (brs, 2F), δ38.25 (brs, 2F), δ35.66 (brs, 2F)

In Synthesis Examples 2 and 3, a compound wherein B¹ is a cyano group was obtained among the diamine compounds represented by formula (9). A compound wherein B¹ is a trifluoromethyl group can also be obtained in the same manner because the cyano group and the methyl fluoride group each are an electron-withdrawing group and show ortho-para orientation.

### Synthesis of Polyamic Acid and Polyimidization

### Example 1

A 50-ml three-neck flask was charged with bis(4-aminophenyl)ether (0.384 g, 1.9 mmol), 1,4-bis(3,4-dicarboxytrifluorophenoxy)tetrafluorobenzoic dianhydride (another name: 4,4′-[(2,3,5,6-tetrafluoro-1,4-phenylene)bis(oxy)]bis(3,5,6-trifluorophthalic anhydride) (1.116 g, 1.9 mmol), and N-methylpyrrolidone (13.5 g). The substances were stirred for 5 days at room temperature under nitrogen atmosphere, and thereby a polyamic acid (solids concentration: 10% by mass) was obtained. Table 1 shows the molecular weight Mw of this polyamic acid.

The polyamic acid (solids concentration: 10% by mass) thus obtained was coated on a Si substrate using a spin coater (MIKASA Co., Ltd.) so as to have a thickness after firing of 5 μm, and then the polyamic acid was fired at 320° C. for 1 hour under nitrogen atmosphere. The obtained film (polyimide film) was evaluated for the contact angle with water and elastic modulus. Table 1 shows the results.

Here, bis(4-aminophenyl)ether is a diamine compound having one ether linkage per molecule and 1,4-bis(3,4-dicarboxytrifluorophenoxy)tetrafluorobenzoic dianhydride is an acid dianhydride having two ether linkages per molecule, and the molar ratio thereof is 1/1. Thus, the total number of the ether linkages is 1×1+1×2=3.

### Example 2

A 50-ml three-neck flask was charged with 4,4′-bis(4-aminophenoxy)biphenyl (0.581 g, 1.6 mmol), 1,4-bis(3,4-dicarboxytrifluorophenoxy)tetrafluorobenzoic dianhydride (0.919 g, 1.6 mmol), and N-methylpyrrolidone (13.5 g), and a polyamic acid (solids concentration: 10% by mass) was obtained in the same manner as in Example 1. Then, a polyimide film was formed from this polyamic acid in the same manner as in Example 1. Table 1 shows the evaluation results of the molecular weight Mw of the polyamic acid and the contact angle with water and elastic modulus of the film.

Here, 4,4′-bis(4-aminophenoxy)biphenyl is a diamine compound having two ether linkages per molecule and 1,4-bis(3,4-dicarboxytrifluorophenoxy)tetrafluorobenzoic dianhydride is an acid dianhydride having two ether linkages per molecule, and the molar ratio thereof is 1/1. Thus, the total number of the ether linkages is 1×2+1×2=4.

### Example 3

A 50-ml three-neck flask was charged with 1,4-bis(4-aminophenoxy)benzene (0.501 g, 1.7 mmol), 1,4-bis(3,4-dicarboxytrifluorophenoxy)tetrafluorobenzoic dianhydride (0.999 g, 1.7 mmol), and N-methylpyrrolidone (13.5 g), and a polyamic acid (solids concentration: 10% by mass) was obtained in the same manner as in Example 1. Then, a polyimide film was formed from this polyamic acid in the same manner as in Example 1. Table 1 shows the evaluation results of the molecular weight Mw of the polyamic acid and the contact angle with water and elastic modulus of the film.

Here, 1,4-bis(4-aminophenoxy)benzene is a diamine compound having two ether linkages per molecule and 1,4-bis(3,4-dicarboxytrifluorophenoxy)tetrafluorobenzoic dianhydride is an acid dianhydride having two ether linkages per molecule, and the molar ratio thereof is 1/1. Thus, the total number of the ether linkages is 1×2+1×2=4.

### Example 4

A 50-ml three-neck flask was charged with 1,3-diamino-2,4,5,6-tetrafluorobenzene (1.170 g, 6.5 mmol), 1,4-bis(3,4-dicarboxytrifluorophenoxy)tetrafluorobenzoic dianhydride (3.780 g, 6.5 mmol), and N-methylpyrrolidone (10.1 g), and a polyamic acid (solids concentration: 33% by mass) was obtained in the same manner as in Example 1. Then, a polyimide film was formed from this polyamic acid in the same manner as in Example 1. Table 1 shows the evaluation results of the molecular weight Mw of the polyamic acid and the contact angle with water and elastic modulus of the film.

Here, 1,3-diamino-2,4,5,6-tetrafluorobenzene is a diamine compound having no ether linkage and 1,4-bis(3,4-dicarboxytrifluorophenoxy)tetrafluorobenzoic dianhydride is an acid dianhydride having two ether linkages per molecule, and the molar ratio thereof is 1/1. Thus, the total number of the ether linkages is 1×0+1×2=2.

### Example 5

A 50-ml three-neck flask was charged with 1,4-bis(4-aminophenoxy)benzene (0.595 g, 2.0 mmol), 4,4′-(hexafluoroisopropylidene)diphthalic anhydride (0.905 g, 2.0 mmol), and N-methylpyrrolidone (13.5 g), and a polyamic acid (solids concentration: 10% by mass) was obtained in the same manner as in Example 1. Then, a polyimide film was formed from this polyamic acid in the same manner as in Example 1. Table 1 shows the evaluation results of the molecular weight Mw of the polyamic acid and the contact angle with water of the film.

Here, 1,4-bis(4-aminophenoxy)benzene is a diamine compound having two ether linkages per molecule and 4,4′-(hexafluoroisopropylidene)diphthalic anhydride is an acid dianhydride having no ether linkage, and the molar ratio thereof is 1/1. Thus, the total number of the ether linkages is 1×2+1×0=2.

### Example 6

A 50-ml three-neck flask was charged with diamine compound (0.486 g) obtained in Synthesis Example 2 and 1,4-bis(4-aminophenoxy)benzene (0.174 g) (total amount thereof: 1.2 mmol), 4,4′-(hexafluoroisopropylidene)diphthalic anhydride (0.529 g, 1.2 mmol), and N-methylpyrrolidone (13.5 g), and a polyamic acid (solids concentration: 10% by mass) was obtained in the same manner as in Example 1. Then, a polyimide film was formed from this polyamic acid in the same manner as in Example 1. Table 1 shows the evaluation results of the molecular weight Mw of the polyamic acid and the contact angle with water of the film.

Here, diamine compound obtained in Synthesis Example 2 and 1,4-bis(4-aminophenoxy)benzene each are a compound having two ether linkages per molecule, and the molar ratio thereof was 1/1 (=0.5/0.5). Further, 4,4′-(hexafluoroisopropylidene)diphthalic anhydride is an acid dianhydride having no ether linkage, and the molar ratio between the sum of the diamine compounds and the acid dianhydride was 1/1. Thus, the total number of the ether linkages is 0.5×2+0.5×2+1×0=2.

TABLE 1

| | | | | | | Amount of | | | | | |
|---|---|---|---|---|---|---|---|---|---|---|---|
| | | | | | | substance | | Polyamic acid | | Polyimide film | |
| | Diamine | | Acid | | Solvent | upper: | Total | Solids | | Contact | |
| | compound | | dianhydride | | NMP | diamine compound | number of | concen- | Molecular | angle with | Elastic |
| | | Amount | | Amount | amount | lower: | ether | tration | weight | water | modulus |
| | Type | (g) | Type | (g) | (g) | acid dianhydride | linkages | (%) | (Mw) | (°) | (MPa) |
| Example 1 | Bis(4-amino- | 0.384 | 1 | 1.116 | 13.5 | 1.9 mmol | 3 | 10 | 190,000 | 90 | 28.5 |
| | phenyl) ether | | | | | 1.9 mmol | | | | | |
| Example 2 | 4,4′-Bis(4-amino- | 0.581 | 1 | 0.919 | 13.5 | 1.6 mmol | 4 | 10 | 170,000 | 92 | 12.7 |
| | phenoxy)biphenyl | | | | | 1.6 mmol | | | | | |
| Example 3 | 1,4-Bis(4-amino- | 0.501 | 1 | 0.999 | 13.5 | 1.7 mmol | 4 | 10 | 340,000 | 91 | 26.3 |
| | phenoxy)benzene | | | | | 1.7 mmol | | | | | |
| Example 4 | 1,3-Diamino-2,4,5,6- | 1.170 | 1 | 3.780 | 10.1 | 6.5 mmol | 2 | 33 | 95,000 | 80 | 80.7 |
| | tetrafluorobenzene | | | | | 6.5 mmol | | | | | |
| Example 5 | 1,4-Bis(4-amino- | 0.595 | 2 | 0.905 | 13.5 | 2.0 mmol | 2 | 10 | 830,000 | 88 | — |
| | phenoxy)benzene | | | | | 2.0 mmol | | | | | |
| Example 6 | 1,4-Bis(4-amino- | 0.174 | 2 | 0.529 | 13.5 | 1.2 mmol | 2 | 10 | 270,000 | 92 | — |
| | phenoxy)benzene | | | | | | | | | | |
| | Diamine compound of | 0.486 | | | | 1.2 mmol | | | | | |
| | Synthesis Example 2 | | | | | | | | | | |

1: 1,4-Bis(3,4-dicarboxytrifluorophenoxy)tetrafluorobenzoic dianhydride
2: 4,4′-(hexafluoroisopropylidene)diphthalic anhydride

### Example 7

A 50-ml three-neck flask was charged with the diamine compound (1.31 g, 1.6 mmol) obtained in Synthesis Example 2, 1,4-bis(3,4-dicarboxytrifluorophenoxy)tetrafluorobenzoic dianhydride (0.94 g, 1.6 mmol), and N-methylpyrrolidone (12.8 g). The substances were stirred for 5 days at room temperature under nitrogen atmosphere, and thereby a polyamic acid (solids concentration: 15% by mass) was obtained. The chemical equation thereof is shown below. Further, Table 2 shows the molecular weight Mw of the obtained polyamic acid.

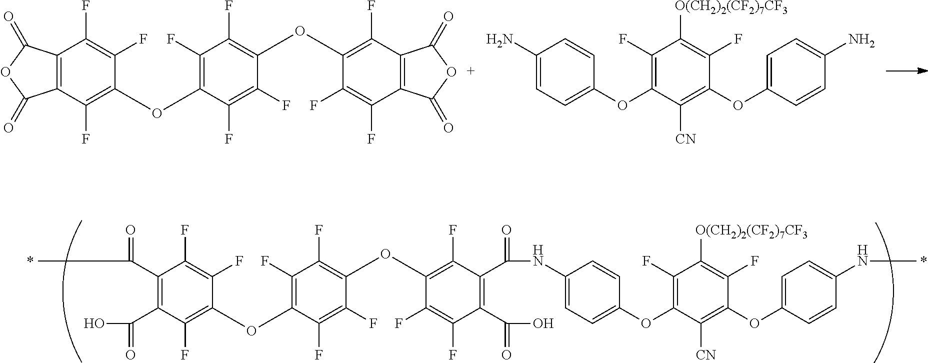

A polyimide film was formed from the obtained polyamic acid (solids concentration: 15% by mass) in the same manner as in Example 1. Table 2 shows the evaluation results of the contact angle with water and elastic modulus of the film.

### Example 8

A 50-ml three-neck flask was charged with the diamine compound (0.889 g, 1.0 mmol) obtained in Synthesis Example 3, 1,4-bis(3,4-dicarboxytrifluorophenoxy)tetrafluorobenzoic dianhydride (0.611 g, 1.0 mmol), and N-methylpyrrolidone (13.5 g), and a polyamic acid (solids concentration: 10% by mass) was obtained in the same manner as in Example 1. Then, a polyimide film was formed from this polyamic acid in the same manner as in Example 1. Table 2 shows the evaluation results of the molecular weight Mw of the polyamic acid and the contact angle with water of the film.

### Example 9

A 50-ml three-neck flask was charged with the diamine compound (0.971 g, 1.2 mmol) obtained in Synthesis Example 2, 2,2-bis(3,4-dicarboxyphenyl)hexafluoropropane dianhydride (0.529 g, 1.2 mmol), and N-methylpyrrolidone (13.5 g), and a polyamic acid (solids concentration: 10% by mass) was obtained in the same manner as in Example 1. Then, a polyimide film was formed from this polyamic acid in the same manner as in Example 1. Table 2 shows the evaluation results of the molecular weight Mw of the polyamic acid and the contact angle with water of the film.

### Example 10

A 50-ml three-neck flask was charged with 1,4-bis(4-aminophenoxy)benzene (0.174 g) and the diamine compound (0.486 g) obtained in Synthesis Example 2 (total amount thereof: 1.2 mmol), 2,2-bis(3,4-dicarboxyphenyl)hexafluoropropane dianhydride (0.529 g, 1.2 mmol), and N-methylpyrrolidone (13.5 g), and a polyamic acid (solids concentration: 10% by mass) was obtained in the same manner as in Example 1. Then, a polyimide film was formed from this polyamic acid in the same manner as in Example 1. Table 2 shows the evaluation results of the molecular weight Mw of the polyamic acid and the contact angle with water of the film.

### Example 11

A 50-ml three-neck flask was charged with 1,4-bis(4-aminophenoxy)benzene (0.157 g) and the diamine compound (0.438 g) obtained in Synthesis Example 2 (total amount thereof: 1.1 mmol), 1,4-bis(3,4-dicarboxytrifluorophenoxy)tetrafluorobenzoic dianhydride (0.625 g, 1.1 mmol), and N-methylpyrrolidone (13.5 g), and a polyamic acid (solids concentration: 10% by mass) was obtained in the same manner as in Example 1. Then, a polyimide film was formed from this polyamic acid in the same manner as in Example 1. Table 2 shows the evaluation results of the molecular weight Mw of the polyamic acid and the contact angle with water of the film.

TABLE 2

| | | | | | | Amount of | | | | |
|---|---|---|---|---|---|---|---|---|---|---|
| | | | | | | substance | | | Polyimide film | |
| | | | Acid | | Solvent | upper: | Polyamic acid | | Contact | |
| | Diamine compound | | dianhydride | | NMP | diamine compound | Solids | Molecular | angle with | Elastic |
| | | Amount | | Amount | amount | lower: | concentration | weight | water | modulus |
| | Type | (g) | Type | (g) | (g) | acid dianhydride | (%) | (Mw) | (°) | (MPa) |
| Example 7 | Diamine compound of | 1.31 | 1 | 0.94 | 12.8 | 1.6 mmol | 15 | 250,000 | 104 | 2.4 |
| | Synthesis Example 2 | | | | | 1.6 mmol | | | | |
| Example 8 | Diamine compound of | 0.889 | 1 | 0.611 | 13.5 | 1.0 mmol | 10 | 170,000 | 104 | — |
| | Synthesis Example 3 | | | | | 1.0 mmol | | | | |
| Example 9 | Diamine compound of | 0.971 | 2 | 0.529 | 13.5 | 1.2 mmol | 10 | 220,000 | 104 | — |
| | Synthesis Example 2 | | | | | 1.2 mmol | | | | |
| Example 10 | 3 | 0.174 | 2 | 0.529 | 13.5 | 1.2 mmol | 10 | 270,000 | 92 | — |
| | Diamine compound of | 0.486 | | | | 1.2 mmol | | | | |
| | Synthesis Example 2 | | | | | | | | | |
| Example 11 | 3 | 0.157 | 1 | 0.625 | 13.5 | 1.1 mmol | 10 | 350,000 | 95 | — |
| | Diamine compound of | 0.438 | | | | 1.1 mmol | | | | |
| | Synthesis Example 2 | | | | | | | | | |

1: 1,4-Bis(3,4-dicarboxytrifluorophenoxy)tetrafluorobenzoic dianhydride
2: 2,2-Bis(3,4-dicarboxyphenyl)hexafluoropropanoic dianhydride
3: 1,4-Bis(4-aminophenoxy)benzene

### Example 12

A 50-ml three-neck flask was charged with 1,4-bis(4-aminophenoxy)benzene (1.09 g, 0.0037 mol), 4,4′-((1,4-phenylene)bis(oxy))bis(3,5,6-trifluorophthalic anhydride) (1.91 g, 0.0037 mol), and N-methylpyrrolidone (12 g). The substances were stirred for 5 days at room temperature under nitrogen atmosphere, and thus a polyamic acid (solids concentration: 10% by mass) was obtained. Table 3 shows the molecular weight Mw of the obtained polyamic acid.

A polyimide film was formed from the obtained polyamic acid (solids concentration: 10% by mass) in the same manner as in Example 1. The contact angle with water of the film was evaluated. Table 3 shows the evaluation result.

Here, 1,4-bis(4-aminophenoxy)benzene is a diamine compound having two ether linkages per molecule and 4,4′-((1,4-phenylene)bis(oxy))bis(3,5,6-trifluorophthalic anhydride) is an acid dianhydride having two ether linkages per molecule, and the molar ratio thereof is 1/1. Thus, the total number of the ether linkages is 1×2+1×2=4.

### Example 13

A 50-ml three-neck flask was charged with 1,4-bis(4-aminophenoxy)benzene (0.534 g, 0.0018 mol), 5,5′-(4,4′-(propane-2,2′-diyl)bis(1,4-phenylene))bis(oxy)bisphthalic anhydride (0.961 g, 0.0018 mol), and N-methylpyrrolidone (13.5 g). The substances were stirred for 5 days at room temperature under nitrogen atmosphere, and thus a polyamic acid (solids concentration: 10% by mass) was obtained. Table 3 shows the molecular weight Mw of the obtained polyamic acid.

A polyimide film was formed from the obtained polyamic acid (solids concentration: 10% by mass) in the same manner as in Example 1. The contact angle with water of the film was evaluated. Table 3 shows the evaluation result.

Here, 1,4-bis(4-aminophenoxy)benzene is a diamine compound having two ether linkages per molecule and 5,5′-(4,4′-(propane-2,2′-diyl)bis(1,4-phenylene))bis(oxy)bisphthalic anhydride is an acid dianhydride having two ether linkages per molecule, and the molar ratio thereof is 1/1. Thus, the total number of the ether linkages is 1×2+1×2=4.

### Example 14

A 50-ml three-neck flask was charged with 1,4-bis(4-aminophenoxy)benzene (1.456 g, 0.005 mol), 4,4′-oxydiphthalic anhydride (1.545 g, 0.005 mol), and N-methylpyrrolidone (27 g). The substances were stirred for 5 days at room temperature under nitrogen atmosphere, and thus a polyamic acid (solids concentration: 10% by mass) was obtained. Table 3 shows the molecular weight Mw of the obtained polyamic acid.

A polyimide film was formed from the obtained polyamic acid (solids concentration: 10% by mass) in the same manner as in Example 1. The contact angle with water of the film was evaluated. Table 3 shows the evaluation result.

Here, 1,4-bis(4-aminophenoxy)benzene is a diamine compound having two ether linkages per molecule and 4,4′-oxydiphthalic anhydride is an acid dianhydride having one ether linkage per molecule, and the molar ratio thereof is 1/1. Thus, the total number of the ether linkages is 1×2 +1×1=3.

TABLE 3

| | | | | | | Amount of | | | | Polyimide |
|---|---|---|---|---|---|---|---|---|---|---|
| | | | | | | substance | | | | film |
| | | | Acid | | Solvent | upper: | Total | Polyamic acid | | Angle of |
| | Diamine compound | | dianhydride | | NMP | diamine compound | number of | Solids | Molecular | contact |
| | | Amount | | Amount | amount | lower: | ether | concentration | weight | with water |
| | Type | (g) | Type | (g) | (g) | acid dianhydride | linkages | (%) | (Mw) | (°) |
| Example 12 | 1,4-Bis(4-amino- | 1.09 | 1 | 1.91 | 12 | 3.7 mmol | 4 | 10 | 78,000 | 82 |
| | phenoxy)benzene | | | | | 3.7 mmol | | | | |
| Example 13 | 1,4-Bis(4-amino- | 0.534 | 2 | 0.961 | 13.5 | 1.8 mmol | 4 | 10 | 230,000 | 90 |
| | phenoxy)benzene | | | | | 1.8 mmol | | | | |
| Example 14 | 1,4-Bis(4-amino- | 1.456 | 3 | 1.545 | 27 | 5.0 mmol | 3 | 10 | 190,000 | 85 |
| | phenoxy)benzene | | | | | 5.0 mmol | | | | |

1: 4,4′-((1,4-Phenylene)bis(oxy))bis(3,5,6-trifluorophthalic anhydride)
2: 5,5′-(4,4′-(propane-2,2′-diyl)bis(1,4-phenylene))bis(oxy)bisphthalic anhydride
3: 4,4′-oxydiphthalic anhydride

### Preparation Example 1

### Preparation of Carbon Dispersion

A 200-ml glass vessel was charged with N-methylpyrrolidone (98 g) as a solvent, ketjen black (Lion Corporation, CARBON ECP600JD, 2 g), polyvinylpyrrolidone (NIPPON SHOKUBAI CO., LTD., K-30, 0.4 g) as a dispersant, and beads with a diameter of 1 mm. The substances were subjected to dispersion treatment using a paint shaker for 1 hour, and then filtered. Thereby, a carbon dispersion (1) was obtained. The particle size distribution of the obtained carbon dispersion (1) was measured using a nano-particle measurement device (HORIBA, Ltd., LB-500), and it was 0.22 μm in an arithmetical computation system. Thus, the carbon black was found to be uniformly dispersed in the solution.

### Preparation of Polyamic Acid Composition and Polyimidization

### Example 15

The polyamic acid (solids concentration: 10% by mass, 10 g) obtained in Example 3 was mixed with a PTFE-dispersed NMP solution (KITAMURA LIMITED, KD-1000AS, dispersion medium: NMP (N-methylpyrrolidone), particle size: 300 nm, 0.63 g), and a uniform solution was formed. Thereby, a PTFE-dispersed polyamic acid composition was obtained. This PTFE polyamic acid composition was coated on a Si wafer using a spin coater (MIKASA Co., Ltd.) so as to have a film thickness after firing of 5 μm, and the composition was fired at 320° C. for 1 hour under nitrogen atmosphere. The obtained film (polyimide film) was subjected to measurement of the contact angle by water, and the angle was 110°.

### Example 16

The carbon dispersion (1) (1.55 g) obtained in Preparation Example 1 was mixed with the polyamic acid (solids concentration: 10% by mass, 10 g) obtained in Example 3, and a uniform solution was formed. Thereby, a carbon-dispersed polyamic acid composition was obtained (solids concentration of polyamic acid: 8.6% by mass). This carbon-dispersed polyamic acid composition was coated on a Si wafer using a spin coater (MIKASA Co., Ltd.) so as to have a film thickness after firing of 5 μm, and the composition was fired at 320° C. for 1 hour under nitrogen atmosphere. Thereby, a polyimide film was obtained.

### Example 17

The carbon dispersion (1) (0.51 g) obtained in Preparation Example 1 was mixed with the polyamic acid (solids concentration: 10% by mass, 10 g) obtained in Example 3, and a carbon-dispersed polyamic acid composition was obtained. Then, this composition was mixed with a PTFE-dispersed NMP solution (KITAMURA LIMITED, KD-1000AS, PTFE solids concentration: 40% by mass, dispersion medium: NMP (N-methylpyrrolidone), particle size: 300 nm, 1.07 g), and the mixture was stirred using a planetary centrifugal mixer (THINKY CORPORATION, THINKY MIXER) so that air bubbles were removed. Thereafter, the obtained composition (polyamic acid composition) was coated on a Si substrate using a spin coater (MIKASA Co., Ltd.) so as to have a thickness after firing of 5 μm, and the composition was fired at 320° C. for 1 hour under nitrogen atmosphere. Thereby, a polyimide film was obtained.

### Example 18

The polyamic acid (solids concentration: 15% by mass, 10 g) obtained in Example 7 was mixed with a PTFE-dispersed NMP solution (KITAMURA LIMITED, KD-1000AS, dispersion medium: NMP (N-methylpyrrolidone), particle size: 300 nm, 0.42 g), and a uniform solution was formed. Thereby, a PTFE-dispersed polyamic acid composition was obtained. This PTFE polyamic acid composition was coated on a Si wafer using a spin coater (MIKASA Co., Ltd.) so as to have a film thickness after firing of 5 μm, and the composition was fired at 320° C. for 1 hour under nitrogen atmosphere. The obtained film (polyimide film) was subjected to measurement of the contact angle by water, and the angle was 110°.

### Example 19

The carbon dispersion (1) (3.96 g) obtained in Preparation Example 1 was mixed with the polyamic acid (solids concentration: 15% by mass, 10 g) obtained in Example 7, and a uniform solution was formed. Thereby, a carbon-dispersed polyamic acid composition was obtained (solids concentration of polyamic acid: 12% by mass). This carbon-dispersed polyamic acid composition was coated on a Si wafer using a spin coater (MIKASA Co., Ltd.) so as to have a film thickness after firing of 5 μm, and the composition was fired at 320° C. for 1 hour under nitrogen atmosphere. Thereby, a polyimide film was obtained.

### Example 20

The carbon dispersion (1) (3.96 g) obtained in Preparation Example 1 was mixed with the polyamic acid (solids concentration: 15% by mass, 10 g) obtained in Example 7 to prepare a carbon-dispersed polyamic acid composition. This composition was mixed with a PTFE-dispersed NMP solution (KITAMURA LIMITED, KD-1000AS, PTFE solids concentration: 40% by mass, dispersion medium: NMP (N-methylpyrrolidone), particle size: 300 nm, 0.94 g) (PTFE solids content: 25% by mass with respect to solids content in polyamic acid), and the mixture was stirred using a planetary centrifugal mixer (THINKY CORPORATION, THINKY MIXER) so that air bubbles were removed. Thereafter, the obtained composition (polyamic acid composition) was coated on a Si substrate using a spin coater (MIKASA Co., Ltd.) so as to have a thickness after firing of 5 μm, and the composition was fired at 320° C. for 1 hour under nitrogen atmosphere. Thereby, a polyimide film was obtained.

### Example 21

The polyamic acid (solids concentration: 10% by mass, 10 g) obtained in Example 12 was mixed with a PTFE-dispersed NMP solution (KITAMURA LIMITED, KD-1000AS, dispersion medium: NMP (N-methylpyrrolidone), particle size: 300 nm, 1.67 g), and a uniform solution was formed. Thereby, a PTFE-dispersed polyamic acid composition was obtained. This PTFE polyamic acid composition was coated on a Si wafer using a spin coater (MIKASA Co., Ltd.) so as to have a film thickness after firing of 5 μm, and the composition was fired at 320° C. for 1 hour under nitrogen atmosphere. The surface resistance value of the obtained film was measured and was 5.72×10¹⁵ Ω/sq. Further, the obtained film (polyimide film) was subjected to measurement of the contact angle with water, and the angle was 87°. Table 4 shows the composition and the evaluation results.

### Example 22

The carbon dispersion (1) (0.75 g) obtained in Preparation Example 1 was mixed with the polyamic acid (solids concentration: 10% by mass, 10 g) obtained in Example 12, and a uniform solution was formed. Thereby, a carbon-dispersed polyamic acid composition was obtained (solids concentration of polyamic acid: 8.6% by mass). This carbon-dispersed polyamic acid composition was coated on a Si wafer using a spin coater (MIKASA Co., Ltd.) so as to have a film thickness after firing of 5 μm, and the composition was fired at 320° C. for 1 hour under nitrogen atmosphere. Thereby, a polyimide film was obtained. The surface resistance value of the obtained film was measured and was 2.57×10⁷ Ω/sq. Further, the obtained film was subjected to measurement of the contact angle with water, and the angle was 79°. Table 4 shows the composition and the evaluation results.

### Example 23

The carbon dispersion (1) (0.75 g) obtained in Preparation Example 1 was mixed with the polyamic acid (solids concentration: 10% by mass, 10 g) obtained in Example 12, and thereby a carbon-dispersed polyamic acid composition was obtained. The obtained composition was mixed with a PTFE-dispersed NMP solution (KITAMURA LIMITED, KD-1000AS, dispersion medium: NMP (N-methylpyrrolidone), particle size: 300 nm, 1.67 g), and the mixture was stirred using a planetary centrifugal mixer (THINKY CORPORATION, THINKY MIXER) so that air bubbles were removed. Thereafter, the obtained composition (polyamic acid composition) was coated on a Si substrate using a spin coater (MIKASA Co., Ltd.) so as to have a thickness after firing of 5 μm, and the composition was fired at 320° C. for 1 hour under nitrogen atmosphere. Thereby, a polyimide film was obtained. The surface resistance value of the obtained film was measured and was 4.16×10⁷ Ω/sq. Further, the obtained film was subjected to measurement of the contact angle with water, and the angle was 86°. Table 4 shows the composition and the evaluation results.

### Example 24

The polyamic acid (solids concentration: 10% by mass, 10 g) obtained in Example 13 was mixed with a PTFE-dispersed NMP solution (KITAMURA LIMITED, KD-1000AS, dispersion medium: NMP (N-methylpyrrolidone), particle size: 300 nm, 1.67 g), and a uniform solution was formed. Thereby, a PTFE-dispersed polyamic acid composition was obtained. This PTFE polyamic acid composition was coated on a Si wafer using a spin coater (MIKASA Co., Ltd.) so as to have a film thickness after firing of 5 μm, and the composition was fired at 320° C. for 1 hour under nitrogen atmosphere. The surface resistance value of the obtained film was measured and was 2.55×10¹⁶ Ω/sq. Further, the obtained film (polyimide film) was subjected to measurement of the contact angle with water, and the angle was 98°. Table 4 shows the composition and the evaluation results.

### Example 25

The carbon dispersion (1) (0.75 g) obtained in Preparation Example 1 was mixed with the polyamic acid (solids concentration: 10% by mass, 10 g) obtained in Example 13, and a uniform solution was formed. Thereby, a carbon-dispersed polyamic acid composition was obtained (solids concentration of polyamic acid: 8.6% by mass). This carbon-dispersed polyamic acid composition was coated on a Si wafer using a spin coater (MIKASA Co., Ltd.) so as to have a film thickness after firing of 5 μm, and the composition was fired at 320° C. for 1 hour under nitrogen atmosphere. Thereby, a polyimide film was obtained. The surface resistance value of the obtained film was measured and was 2.46×10¹⁶ Ω/sq. Further, the obtained film (polyimide film) was subjected to measurement of the contact angle with water, and the angle was 85°. Table 4 shows the composition and the evaluation results.

### Example 26

The carbon dispersion (1) (0.75 g) obtained in Preparation Example 1 was mixed with the polyamic acid (solids concentration: 10% by mass, 10 g) obtained in Example 13 to prepare a carbon-dispersed polyamic acid composition. This composition was mixed with a PTFE-dispersed NMP solution (KITAMURA LIMITED, KD-1000AS, dispersion medium: NMP (N-methylpyrrolidone), particle size: 300 nm, 1.67 g), and the mixture was stirred using a planetary centrifugal mixer (THINKY CORPORATION, THINKY MIXER) so that air bubbles were removed. Thereafter, the obtained composition (polyamic acid composition) was coated on a Si substrate using a spin coater (MIKASA Co., Ltd.) so as to have a thickness after firing of 5 μm, and the composition was fired at 320° C. for 1 hour under nitrogen atmosphere. Thereby, a polyimide film was obtained. The surface resistance value of the obtained film was measured and was 3.48×10¹⁶ Ω/sq. Further, the obtained film was subjected to measurement of the contact angle with water, and the angle was 88°. Table 4 shows the composition and the evaluation results.

### Carbon Black Dispersed, Dispersion Added Upon Polymerization

### Example 27

A 200-ml three-neck flask was charged with 1,3-diamino-2,4,5,6-tetrafluorobenzene (4.73 g, 26 mmol), 4,4′-[(2,3,5,6-tetrafluoro-1,4-phenylene)bis(oxy)]bis(3,5,6-trifluorophthalic anhydride) (15.28 g, 26 mmol), the carbon dispersion (1) (52.8 g), and N-methylpyrrolidone (28.2 g). The substances were stirred for 5 days at room temperature under nitrogen atmosphere, and thereby a carbon-dispersed polyamic acid composition (1) (solids concentration of polyamic acid: 20.0%) was obtained.

The obtained carbon-dispersed polyamic acid composition (1) was coated on a Si wafer using a spin coater (MIKASA Co., Ltd.) so as to have a film thickness after firing of 5μ, and the composition was fired at 320° C. for 1 hour under nitrogen atmosphere. The surface resistance value of the obtained film (polyimide film 1) was measured and was 1.95×10⁶ Ω/sq, and measurement of the contact angle with water showed that the angle was 80°. Table 4 shows the composition and the evaluation results.

### Carbon Black Dispersed, Mixed after Polymerization)

### Example 28

A 200-ml three-neck flask was charged with 1,3-diamino-2,4,5,6-tetrafluorobenzene (2.84 g, 16 mmol), 4,4′-[(2,3,5,6-tetrafluoro-1,4-phenylene)bis(oxy)]bis(3,5,6-trifluorophthalic anhydride) (9.17 g, 16 mmol), and N-methylpyrrolidone (28.0 g). The substances were stirred for 5 days at room temperature under nitrogen atmosphere, and a polyamic acid solution (a) (solids concentration of polyamic acid: 30.0%) was obtained.

The carbon dispersion (1) (31.7 g) obtained in Preparation Example 1 was mixed with the polyamic acid solution (a) (40 g), and a uniform solution was formed.

Thereby, a carbon-dispersed polyamic acid composition (2) was obtained (solids concentration of polyamic acid: 20.0%). This carbon-dispersed polyamic acid composition (2) was coated on a Si wafer using a spin coater (MIKASA Co., Ltd.) so as to have a film thickness after firing of 5μ, and the composition was fired at 320° C. for 1 hour under nitrogen atmosphere. The surface resistance value of the obtained film (polyimide film 2) was measured and was 1.13×10⁶ Ω/sq, and measurement of the contact angle with water showed that the angle was 80°. Table 4 shows the composition and the evaluation results.

### PTFE Dispersed

### Example 29

No carbon dispersion was added to the polyamic acid solution (a) (10 g) produced in Example 28, and PTFE (DAIKIN INDUSTRIES, ltd., Lubron, 0.22 g) was added thereto, and the mixture was stirred using a planetary centrifugal mixer (THINKY CORPORATION, THINKY MIXER) so that air bubbles were removed. Thereafter, the obtained composition (polyamic acid composition (3)) was coated on a Si substrate using a spin coater (MIKASA Co., Ltd.) so as to have a thickness after firing of 5μ, and the composition was fired at 320° C. for 1 hour under nitrogen atmosphere. The surface resistance value of the obtained film (polyimide film 3) was measured and was 1.89×10¹⁸ Ω/sq, and measurement of the contact angle with water showed that the angle was 100°. Table 4 shows the composition and the evaluation results.

### Carbon Black Dispersed+PTFE Dispersed

### Example 30

The carbon dispersion (1) (63.3 g) obtained in Preparation Example 1 was mixed with the polyamic acid solution (a) (40 g) obtained in Example 28 to provide a carbon-dispersed polyamic acid composition (2). The composition (2) (10 g) was mixed with PTFE (DAIKIN INDUSTRIES, ltd., Lubron, 0.22 g), and the mixture was stirred using a planetary centrifugal mixer (THINKY CORPORATION, THINKY MIXER) so that air bubbles were removed. Thereafter, the obtained composition (polyamic acid composition (4)) was coated on a Si substrate using a spin coater (MIKASA Co., Ltd.) so as to have a thickness after firing of 5μ, and the composition was fired at 320° C. for 1 hour under nitrogen atmosphere. The surface resistance value of the obtained film (polyimide film 4) was measured and was 8.68×10⁵ Ω/sq, and measurement of the contact angle with water showed that the angle was 100°. Table 4 shows the composition and the evaluation results.

### Carbon Black Dispersed, Dispersion Added Upon Polymerization

### Example 31

A 200-ml three-neck flask was charged with 4,4′-diamino-2,2′-bis(trifluoromethyl)biphenyl (5.32 g, 17 mmol), 4,4′-[(2,3,5,6-tetrafluoro-1,4-phenylene)bis(oxy)]bis(3,5,6-trifluorophthalic anhydride) (9.68 g, 17 mmol), the carbon dispersion (1) (39.6 g) obtained in Preparation Example 1, and N-methylpyrrolidone (46.2 g). The substances were stirred for 5 days at room temperature under nitrogen atmosphere, and thereby a carbon-dispersed polyamic acid composition (5) (solids concentration of polyamic acid: 15.0%) was obtained. The obtained carbon-dispersed polyamic acid composition (5) was coated on a Si wafer using a spin coater (MIKASA Co., Ltd.) so as to have a film thickness after firing of 5μ, and the composition was fired at 320° C. for 1 hour under nitrogen atmosphere. The surface resistance value of the obtained film (polyimide film 5) was measured and was 2.10×10⁶ Ω/sq, and measurement of the contact angle with water showed that the angle was 80°. Table 4 shows the composition and the evaluation results.

### Carbon Black Dispersed, Mixed after Polymerization

### Example 32

A 200-ml three-neck flask was charged with 4,4′-diamino-2,2′-bis(trifluoromethyl)biphenyl (2.13 g, 7.0 mmol), 4,4′-[(2,3,5,6-tetrafluoro-1,4-phenylene)bis(oxy)]bis(3,5,6-trifluorophthalic anhydride (3.87 g, 7.0 mmol), and N-methylpyrrolidone (34.0 g). The substances were stirred for 5 days at room temperature under nitrogen atmosphere, and a polyamic acid solution (b) (solids concentration of polyamic acid: 15.0%) was obtained.

The carbon dispersion (1) (15.9 g) obtained in Preparation Example 1 was mixed with the polyamic acid solution (b) (40 g), and a uniform solution was formed. Thereby, a carbon-dispersed polyamic acid composition (6) (solids concentration of polyamic acid: 12%) was obtained. This carbon-dispersed polyamic acid composition (6) was coated on a Si wafer using a spin coater (MIKASA Co., Ltd.) so as to have a film thickness after firing of 5μ, and the composition was fired at 320° C. for 1 hour under nitrogen atmosphere. The surface resistance value of the obtained film (polyimide film 6) was measured and was 3.42×10⁶ Ω/sq, and measurement of the contact angle with water showed that the angle was 80°. Table 4 shows the composition and the evaluation results.

### PTFE Dispersed

### Example 33

No carbon was added to the polyamic acid solution (b) (10 g) produced in Example 32, and PTFE (DAIKIN INDUSTRIES, ltd., Lubron, 0.17 g) was added thereto, and the mixture was stirred using a planetary centrifugal mixer (THINKY CORPORATION, THINKY MIXER) so that air bubbles were removed. Thereafter, the obtained composition (polyamic acid composition (7)) was coated on a Si substrate using a spin coater (MIKASA Co., Ltd.) so as to have a thickness after firing of 5μ, and the composition was fired at 320° C. for 1 hour under nitrogen atmosphere. The surface resistance value of the obtained film (polyimide film 7) was measured and was 3.17×10¹⁷ Ω/sq, and measurement of the contact angle with water showed that the angle was 100°. Table 4 shows the composition and the evaluation results.

### Carbon Black Dispersed+PTFE Dispersed

### Example 34

The carbon dispersion (1) (63.3 g) obtained in Preparation Example 1 was mixed with the polyamic acid solution (b) (40 g) obtained in Example 32 to provide a carbon-dispersed polyamic acid composition (6). The composition (6) (10 g) was mixed with PTFE (DAIKIN INDUSTRIES, ltd., Lubron, 0.13 g), and the mixture was stirred using a planetary centrifugal mixer (THINKY CORPORATION, THINKY MIXER) so that air bubbles were removed. Thereafter, the obtained composition (polyamic acid composition (8)) was coated on a Si substrate using a spin coater (MIKASA Co., Ltd.) so as to have a thickness after firing of 5μ, and the composition was fired at 320° C. for 1 hour under nitrogen atmosphere. The surface resistance value of the obtained film (polyimide film 8) was measured and was 3.52×10⁵ Ω/sq, and measurement of the contact angle with water showed that the angle was 100°. Table 4 shows the composition and the evaluation results.

### PTFE Dispersed, Dispersion Added after Polymerization

### Example 35

The polyamic acid solution (a) (40 g) produced in Example 28 was mixed with a PTFE-dispersed NMP solution (KITAMURA LIMITED, KD-1000AS, dispersion medium: NMP (N-methylpyrrolidone), particle size: 300 nm, 3.33 g), and a uniform solution was formed. Thereby, a PTFE-dispersed polyamic acid composition (9) (solids concentration of polyamic acid: 29%) was obtained. This PTFE-dispersed polyamic acid composition (9) was coated on a Si wafer using a spin coater (MIKASA Co., Ltd.) so as to have a film thickness after firing of 5μ, and the composition was fired at 320° C. for 1 hour under nitrogen atmosphere. The surface resistance value of the obtained film (polyimide film 9) was measured and was 4.56×10¹⁷ Ω/sq, and measurement of the contact angle with water showed that the angle was 108°. Table 4 shows the composition and the evaluation results.

### No Carbon Black Dispersed

### Example 36

No carbon was added to the polyamic acid solution (a) produced in Example 28, and the solution (a) was coated on a Si substrate using a spin coater (MIKASA Co., Ltd.) so as to have a thickness after firing of 5μ, and the solution was fired at 320° C. for 1 hour under nitrogen atmosphere. The surface resistance value of the obtained film (polyimide film 10) was measured and was 1.89×10¹⁷ Ω/sq, and measurement of the contact angle with water showed that the angle was 80°. Table 4 shows the composition and the evaluation results.

### No Carbon Black Dispersed

### Example 37

No carbon was added to the polyamic acid solution (b) produced in Example 32, and the solution (b) was coated on a Si substrate using a spin coater (MIKASA Co., Ltd.) so as to have a thickness after firing of 5μ, and the solution was fired at 320° C. for 1 hour under nitrogen atmosphere. The surface resistance value of the obtained film (polyimide film 11) was measured and was 1.57×10¹⁷ Ω/sq, and measurement of the contact angle with water showed that the angle was 80°. Table 4 shows the composition and the evaluation results.

TABLE 4

| | | | | | |
|---|---|---|---|---|---|
| Example 21 | Example 22 | Example 23 | Example 24 | Example 25 | Example 26 |

| | | | |
|---|---|---|---|
| Polyamic | Acid | 1 | 2 |
| acid | anhydride | | |

| | |
|---|---|
| Diamine | TPE-Q |
| compound | |

| | | | | | | | |
|---|---|---|---|---|---|---|---|
| CB/ | Type | PTFE | CB | CB + PTFE | PTFE | CB | CB + PTFE |
| fluoro- | | | | (combina- | | | (combina- |
| resin | | | | tion) | | | tion) |
| | Timing of | After | After | After | After | After | After |
| | addition to/ | polymer- | polymer- | polymer- | polymer- | polymer- | polymer- |
| | mixing with | ization | ization | ization | ization | ization | ization |
| | polyamic | | | | | | |
| | acid | | | | | | |

| | | | | | | |
|---|---|---|---|---|---|---|
| Surface resistance | 5.72 × 10¹⁵ | 2.57 × 10⁷ | 4.16 × 10⁷ | 2.55 × 10¹⁵ | 2.46 × 10¹⁵ | 3.48 × 10¹⁵ |
| value (Ω/sq) | | | | | | |
| Contact angle(°) | 87 | 79 | 86 | 98 | 85 | 88 |

| | | Example 27 | Example 28 | Example 29 | Example 30 | Example 31 | Example 32 |
|---|---|---|---|---|---|---|---|
| Polyamic acid composition | | (1) | (2) | (3) | (4) | (5) | (6) |
| Polyamic | Acid | 3 | | | | | |
| acid | anhydride | | | | | | |
| | Diamine | 4FMPD | 4FMPD | 4FMPD | 4FMPD | TFMB | TFMB |
| | compound | | | | | | |
| CB/ | Type | CB | CB | PTFE | CB + PTFE | CB | CB |
| fluoro- | | | | | (Combina- | | |
| resin | | | | | tion) | | |
| | Timing of | Upon | After | After | After | Upon | After |
| | addition to/ | polymer- | polymer- | polymer- | polymer- | polymer- | polymer- |
| | mixing with | ization | ization | ization | ization | ization | ization |
| | polyamic | | | | | | |
| | acid | | | | | | |
| Name of polyimide film | | 1 | 2 | 3 | 4 | 5 | 6 |
| Surface resistance | | 1.95 × 10⁶ | 1.13 × 10⁵ | 1.89 × 10¹⁸ | 8.68 × 10⁵ | 2.10 × 10⁸ | 3.42 × 10⁸ |
| value (Ω/sq) | | | | | | | |
| Contact angle (°) | | 80 | 80 | 100 | 100 | 80 | 80 |
| | | | Example 33 | Example 34 | Example 35 | Example 36 | Example 37 |
| | Polyamic acid composition | | (7) | (8) | (9) | (a) | (b) |
| | Polyamic | Acid | 3 | | | | |
| | acid | anhydride | | | | | |
| | | Diamine | TFMB | TFMB | 4FMPD | 4FMPD | TFMB |
| | | compound | | | | | |
| | CB/ | Type | PTFE | CB + PTFE | Dispersed | — | — |
| | fluoro- | | | (Combina- | PTFE | | |
| | resin | | | tion) | | | |
| | | Timing of | After | After | After | — | — |
| | | addition to/ | polymer- | polymer- | polymer- | | |
| | | mixing with | ization | ization | ization | | |
| | | polyamic | | | | | |
| | | acid | | | | | |

| | | | | | |
|---|---|---|---|---|---|
| Name of polyimide film | 7 | 8 | 9 | 10 | 11 |
| Surface resistance | 3.17 × 10¹⁷ | 3.52 × 10⁵ | 4.56 × 10¹⁷ | 1.89 × 10¹⁷ | 1.57 × 10¹⁷ |
| value (Ω/sq) | | | | | |
| Contact angle (°) | 100 | 100 | 108 | 80 | 80 |

1: 4,4′-((1,4-Phenylene)bis(oxy))bis(3,5,6-trifluorophthalic anhydride)
2: 5,5′-(4,4′-(Isopropylidene)bis(4,1-phenylene)) bisoxydiphthalic anhydride
3: 4,4′-[(2,3,5,6-tetrafluoro-1,4-phenylene) bis(oxy)]bis(3,5,6-trifluorophthalic anhydride
The respective symbols in Table 4 represent as follows.
TPE-Q: 1,4-bis(4-aminophenoxy)benzene
4FMPD: 1,3-diamino-2,4,5,6-tetrafluorobenzene
TFMB: 4,4′-diamino2,2′-bis(trifluoromethyl)biphenyl
CB: carbon black
PTFE: polytetrafluoroethylene

1. A highly water-repellent polyimide for copier members, comprising:
one or more acid dianhydrides; and
one or more diamine compounds,
at least one compound of the acid dianhydrides and the diamine compounds including an ether linkage and/or a thioether linkage in its molecule, and
the total number of ether linkages and thioether linkages in polymerized repeating units derived from the acid dianhydrides and the diamine compounds of the polyimide being 2 or greater.

2. The highly water-repellent polyimide for copier members according to claim 1,
wherein the acid dianhydrides include at least a compound represented by formula (4): 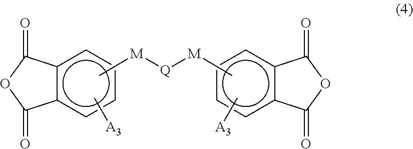
wherein A represents a hydrogen atom or a fluorine atom; Q represents a divalent organic group; and M represents an oxygen atom or a sulfur atom.

3. The highly water-repellent polyimide for copier members according to claim 1,
wherein the diamine compounds include a compound represented by formula (9): 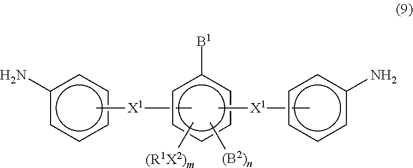
wherein B¹ represents CF₃ or CN; B²s are the same as or different from each other, and each represent H, F, Cl, Br, or I; R¹ represents a C1-C20 halogen-substituted alkyl group; X¹s are the same as or different from each other, and each represent O or S; X² represents O or S; n represents the number of B², and is an integer of 0 to 2; m represents the number of substitutions in the group represented by R¹X², and is an integer of 1 to 3; and n+m=3.

4. The highly water-repellent polyimide for copier members according to claim 3,
wherein R¹ in formula (9) is a C1-C20 fluorine-substituted alkyl group.

5. The highly water-repellent polyimide for copier members according to claim 3,
wherein B² in formula (9) is F which represents a fluorine atom.

6. The highly water-repellent polyimide for copier members according to claim 1,
wherein the polyimide includes a repeating unit represented by formula (19): 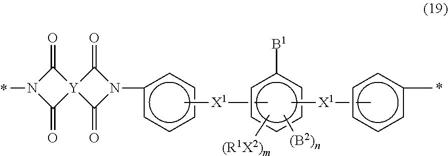
wherein Y represents a tetravalent organic group; B¹ represents CF₃ or CN; B²s are the same as or different from each other, and each represent H, F, Cl, Br, or I; R¹ represents a C1-C20 halogen-substituted alkyl group; X¹s are the same as or different from each other, and each represent O or S; X² represents O or S; n represents the number of B², and is an integer of 0 to 2; m represents the number of substitutions in the group represented by R¹X², and is an integer of 1 to 3; and n+m=3.

7. A polyimide composition, comprising
the polyimide according to claim 1.

8. A polyamic acid composition for preparing highly water-repellent polyimides for copier members, comprising
a polyamic acid obtainable from one or more acid dianhydrides and one or more diamine compounds,
at least one compound of the acid dianhydrides and the diamine compounds including an ether linkage and/or a thioether linkage in its molecule, and
the total number of ether linkages and thioether linkages in polymerized repeating units derived from the acid dianhydrides and the diamine compounds of the polyamic acid being 2 or greater.

9. The polyamic acid composition for preparing highly water-repellent polyimides for copier members according to claim 8, further comprising
carbon black and/or fluororesin.

10. The polyamic acid composition for preparing highly water-repellent polyimides for copier members according to claim 8,
wherein the acid dianhydrides include at least a compound represented by formula (4): 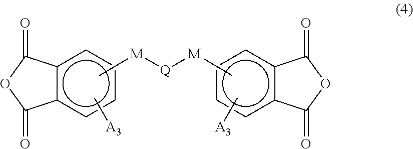
wherein A represents a hydrogen atom or a fluorine atom; Q represents a divalent organic group; and M represents an oxygen atom or a sulfur atom.

11. The polyamic acid composition for preparing highly water-repellent polyimides for copier members according to claim 8,
wherein the polyamic acid includes a repeating unit represented by formula (16): 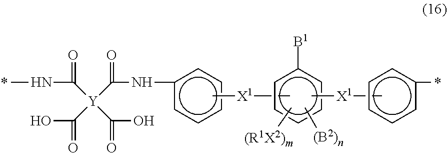
wherein Y represents a tetravalent organic group; B¹ represents CF₃ or CN; B²s are the same as or different from each other, and each represent H, F, Cl, Br, or I; R¹ represents a C1-C20 halogen-substituted alkyl group; X¹s are the same as or different from each other, and each represent O or S; X² represents O or S; n represents the number of B², and is an integer of 0 to 2; m represents the number of substitutions in the group represented by R¹X², and is an integer of 1 to 3; and n+m=3.

12. The polyamic acid composition for preparing highly water-repellent polyimides for copier members according to claim 11,
wherein R¹ in formula (16) is a C1-C20 fluorine-substituted alkyl group.

13. The polyamic acid composition for preparing highly water-repellent polyimides for copier members according to claim 11,
wherein B² in formula (16) is F which represents a fluorine atom.

14. The polyamic acid composition for preparing highly water-repellent polyimides for copier members according to claim 8,
wherein the polyamic acid includes a repeating unit represented by formula (18): 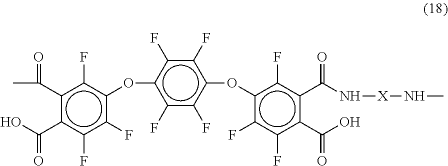
wherein X represents a divalent organic group.

15. A polyimide composition, which is obtainable by imidizing the polyamic acid composition according to claim 8.

16. The highly water-repellent polyimide for copier members according to claim 2,
wherein the diamine compounds include a compound represented by formula (9): 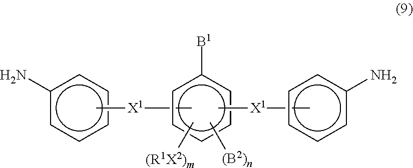
wherein B¹ represents CF₃ or CN; B²s are the same as or different from each other, and each represent H, F, Cl, Br, or I; R¹ represents a C1-C20 halogen-substituted alkyl group; X¹s are the same as or different from each other, and each represent O or S; X² represents O or S; n represents the number of B², and is an integer of 0 to 2; m represents the number of substitutions in the group represented by R¹X², and is an integer of 1 to 3; and n+m=3.

17. The highly water-repellent polyimide for copier members according to claim 4,
wherein B² in formula (9) is F which represents a fluorine atom.

18. The highly water-repellent polyimide for copier members according to claim 3,
wherein the polyimide includes a repeating unit represented by formula (19): 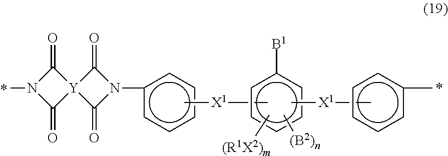
wherein Y represents a tetravalent organic group; B¹ represents CF₃ or CN; B²s are the same as or different from each other, and each represent H, F, Cl, Br, or I; R¹ represents a C1-C20 halogen-substituted alkyl group; X¹s are the same as or different from each other, and each represent O or S; X² represents O or S; n represents the number of B², and is an integer of 0 to 2; m represents the number of substitutions in the group represented by R¹X², and is an integer of 1 to 3; and n+m=3.

19. The highly water-repellent polyimide for copier members according to claim 4,
wherein the polyimide includes a repeating unit represented by formula (19): 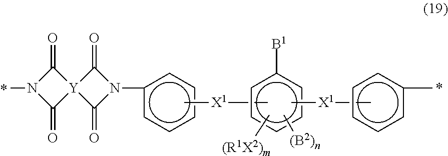
wherein Y represents a tetravalent organic group; B¹ represents CF₃ or CN; B²s are the same as or different from each other, and each represent H, F, Cl, Br, or I; R¹ represents a C1-C20 halogen-substituted alkyl group; X¹s are the same as or different from each other, and each represent O or S; X² represents O or S; n represents the number of B², and is an integer of 0 to 2; m represents the number of substitutions in the group represented by R¹X², and is an integer of 1 to 3; and n+m=3.

20. The highly water-repellent polyimide for copier members according to claim 5,
wherein the polyimide includes a repeating unit represented by formula (19): 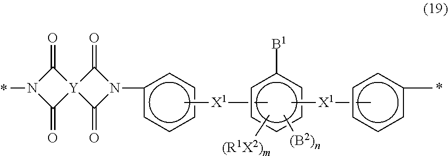
wherein Y represents a tetravalent organic group; B¹ represents CF₃ or CN; B²s are the same as or different from each other, and each represent H, F, Cl, Br, or I; R¹ represents a C1-C20 halogen-substituted alkyl group; X¹s are the same as or different from each other, and each represent O or S; X² represents O or S; n represents the number of B², and is an integer of 0 to 2; m represents the number of substitutions in the group represented by R¹X², and is an integer of 1 to 3; and n+m=3.
